(19) United States
(12) Patent Application Publication
(10) Pub. No.: US 2012/0096455 A1
(43) Pub. Date: Apr. 19, 2012

(54) APPARATUS AND METHOD FOR MANAGEMENT OF SOFTWARE

(75) Inventors: Akira Katsumata, Kawasaki (JP); Shinya Shibata, Kawasaki (JP); Kazufumi Iwahara, Kawasaki (JP)

(73) Assignee: FUJITSU LIMITED, Kawasaki-shi (JP)

(21) Appl. No.: 13/252,767

(22) Filed: Oct. 4, 2011

(30) Foreign Application Priority Data
Oct. 19, 2010 (JP) 2010-234541

(51) Int. Cl. G06F 9/445; G06F 15/16

(52) U.S. Cl. 717/177

(57) ABSTRACT

In a software management apparatus, a storage unit stores use order information that indicates in what order a plurality of pieces of software are used upon request from a first information processing apparatus. Based on the progress of software running on a plurality of second information processing apparatuses and the use order information stored in the storage unit, a prediction unit predicts which software the first information processing apparatus is expected to request in the next place. An installation unit installs the software predicted by the prediction unit on one of the second information processing apparatuses.

### CROSS-REFERENCE TO RELATED APPLICATION

This application is based upon and claims the benefit of priority of the prior Japanese Patent Application No. 2010-234541, filed on Oct. 19, 2010, the entire contents of which are incorporated herein by reference.

### FIELD

The embodiments discussed herein relate to an apparatus and method for management of software.

### BACKGROUND

Information processing systems have widely been used in recent years, including those formed from a plurality of information processing devices that perform processing operations while communicating with each other via a network. Some of those information processing systems are configured such that one information processing device (server device) executes particular software upon request from another information processing device (client device) and sends the processing result back to the requesting client device. For example, a web browser running on a client device issues a request for execution of software, which is sent over the Internet to a server device in the information processing system. This software delivery model is sometimes called “software as a service” (SaaS).

A software installation process may be invoked on each relevant information processing device to make particular software executable thereon. In this regard, Japanese Laid-open Patent Publication No. 5-165610, for example, proposes a method of automatically installing software development tools in an efficient way by using information that defines a development environment in each particular location where the software development work takes place.

On the other hand, Japanese Laid-open Patent Publication No. 2003-203156 proposes a method of scheduling resources such as vehicles and manufacturing equipment. The proposed method accepts reservations for resources in specific dates and times and predicts therefrom a demand of resources based on the prospect of future resource reservations. Also, Japanese Laid-open Patent Publication No. 2001-306775 proposes a method of managing software for electronic device development. The proposed method automatically configures development software tools on the basis of information that indicates how those tools will be allocated to project participants.

As described above, there is an information processing system in which one group of information processing devices (e.g., server devices) execute software upon request from another group of information processing devices (e.g., client devices). The latter group of information processing devices may request a variety of software, and as the number of such software programs increases, it becomes more difficult to efficiently operate the information processing system because of the problems of software installation described below.

Suppose, for example, that the system is configured such that every potentially demanded software program is previously installed on information processing devices. This configuration, however, consumes a large amount of storage space in hard disk drives or other storage devices. Further, a large number of information processing devices may have to be deployed in the case where the potentially demanded programs include those that may conflict with each other when installed on the same information processing device. The noted system configuration thus necessitates more computing resources such as processors and storage devices.

As an alternative approach, installation of software may be initiated each time a new program is requested. While this method avoids increased consumption of computing resources, the requesting user has to wait until the system installs the desired software and makes it ready to execute. In other words, the turn around time (TAT) of the information processing system is increased.

### SUMMARY

According to an aspect of the invention, there is provided a software management apparatus for managing software that is executed, upon request from a first information processing apparatus, by one or more second information processing apparatuses. This apparatus includes the following elements: a storage unit which stores execution order information indicating in what order a plurality of pieces of software are used; a prediction unit which monitors progress of first software on the second information processing apparatuses and predicts second software that is expected to be requested from the first information processing apparatus subsequently to the first software, based on the progress of the first software and the execution order information stored in the storage unit; and an installation unit which installs the predicted second software on at least one of the second information processing apparatuses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a software management apparatus according to a first embodiment;

FIG. 2 illustrates an information processing system according to a second embodiment;

FIG. 3 illustrates a structure of an execution server;

FIG. 4 illustrates a hardware configuration of an application management server;

FIG. 5 is a functional block diagram of an application management server;

FIG. 6 illustrates an example data structure of an application management table;

FIG. 7 illustrates an example data structure of design step definition tables;

FIG. 8 illustrates an example data structure of a usage record management table;

FIG. 9 illustrates an example of an application selection screen;

FIG. 10 illustrates an example of a version selection screen;

FIG. 11 is a flowchart of an application prediction process according to the second embodiment;

FIG. 12 is a flowchart of an installation process;

FIG. 13 is a sequence diagram illustrating how an installation process is executed;

FIG. 14 is a flowchart of an application launching process;

FIG. 15 is a first sequence diagram illustrating how an application launching process is executed;

FIG. 16 is a second sequence diagram illustrating how an application launching process is executed;

FIG. 17 is a flowchart of a process of application workload determination;

FIG. 18 is a sequence diagram illustrating how applications are added depending of machine load;

FIG. 19 is a flowchart of a process of determining which applications to uninstall;

FIG. 20 is a flowchart of an uninstallation process;

FIG. 21 is a sequence diagram illustrating how an uninstallation process is executed;

FIG. 22 is a functional block diagram of an application management server according to a third embodiment;

FIG. 23 illustrates an example data structure of use plan tables;

FIG. 24 is a flowchart of an application prediction process according to the third embodiment;

FIG. 25 is a functional block diagram of an application management server according to a fourth embodiment;

FIG. 26 is a flowchart of a process of correction parameter calculation; and

FIG. 27 illustrates a specific example of a correction parameter calculation process.

### DESCRIPTION OF EMBODIMENTS

Embodiments of the present invention will be described below with reference to the accompanying drawings, wherein like reference numerals refer to like elements throughout.

### (a) First Embodiment

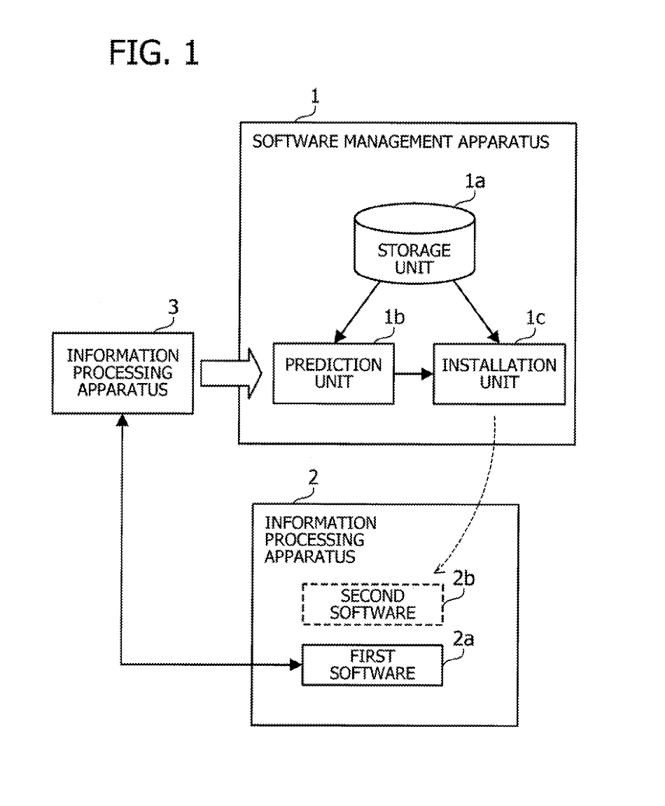

FIG. 1 illustrates a software management apparatus according to a first embodiment. The illustrated software management apparatus 1 manages software that is executed by an information processing apparatus 2 (or a plurality of information processing apparatuses including this information processing apparatus 2) upon request from another information processing apparatus 3. The software managed by the software management apparatus 1 may be application software (referred to hereafter as “applications” where appropriate). The software management apparatus 1 includes a storage unit 1a, a prediction unit 1b, and an installation unit 1c.

The storage unit 1a stores use order information that indicates in what order multiple pieces of software (including first software 2a and second software 2b) are supposed to be used. This use order information may describe a general order of software to be used in each particular category of projects. For example, in the case of a project of developing electronic circuits, the project participants are expected to use a logic design application, a logic simulator application, and component layout and wire routing applications in that order. The use order information describes this order of applications. It is assumed, in the first embodiment described below, that the use order information specifies that first software 2a is used before second software 2b.

The prediction unit 1b monitors progress of the first software 2a executed on the information processing apparatus 2 (or in a plurality of information processing apparatuses). The progress of the first software 2a may be determined on the basis of, for example, log records of the information processing apparatus 2 (or each of the plurality of information processing apparatuses). Based on the observed progress of the first software 2a and the use order information stored in the storage unit 1a, the prediction unit 1b predicts which software (e.g., second software 2b) the information processing apparatus 3 is expected to request.

As the use of second software 2b is predicted by the prediction unit 1b, the installation unit 1c installs that second software 2b on the information processing apparatus 2 (or at least one of the plurality of information processing apparatuses). The second software 2b is stored in a predetermined storage device. The installation process may include copying programs corresponding to the second software 2b from this predetermined storage device to a different storage device used by the information processing apparatus 2 (or other information processing apparatuses). The installation process may further include decompressing compressed programs in the latter storage device to restore their original non-compressed form. Where necessary, the installation unit 1c may delegate those installation tasks to other devices.

The prediction unit 1b may be configured to control when to install the second software 2b, based on the execution start time of the first software 2a. For example, the prediction unit 1b may control the installation process in such a way that the second software 2b is installed immediately after the execution of the first software 2a is detected. Another example is that the second software 2b is installed upon expiration of a predetermined delay time after the execution of the first software 2a is started. The length of this delay time may vary depending on the category of software and projects.

The prediction unit 1b may further make reference to plan data in controlling when to install the second software 2b. This plan data is produced by a user of the information processing apparatus 3 (or by a user group to which the user belongs) to indicate scheduled use time of each piece of software. Also, the storage unit 1a for storing use order information may be located in some other apparatus outside the software management apparatus 1. When this is the case, the prediction unit 1b is configured to receive use order information via a network from the apparatus accommodating the storage unit 1a. The software management apparatus 1 may be implemented as a computer and a software management program executed thereon.

In operation of the software management apparatus 1 described above, the prediction unit 1b monitors progress of the first software 2a on the information processing apparatus 2 (and other similar information processing apparatuses). Based on the progress of the first software 2a and the use order information stored in the storage unit 1a, the prediction unit 1b predicts which software the information processing apparatus 3 is expected to request. For example, the prediction unit 1b predicts the use of second software 2b. The installation unit 1c then installs this second software 2b on the information processing apparatus 2 (or at least one of the similar information processing apparatuses).

The proposed software management apparatus 1 enables efficient operation of an information processing apparatus 2 (and other similar information processing apparatuses) that executes software upon request from another information processing apparatus 3. The software management apparatus 1 provides this feature without the need for previously installing every piece of software in the former information processing apparatus 2 (and other similar information processing apparatuses) which may be requested by the latter information processing apparatus 3. It is therefore possible to reduce the consumption of computational resources such as processors and storage devices. The proposed software management apparatus 1 also predicts software to be requested and installs that software on at least one information processing apparatus before its execution is requested by the information processing apparatus 3. This feature makes it possible to reduce the waiting time from request to execution.

The following sections will describe second to fourth embodiments of an information processing system that uses a plurality of server computers to execute applications as requested from a terminal device.

### (b) Second Embodiment

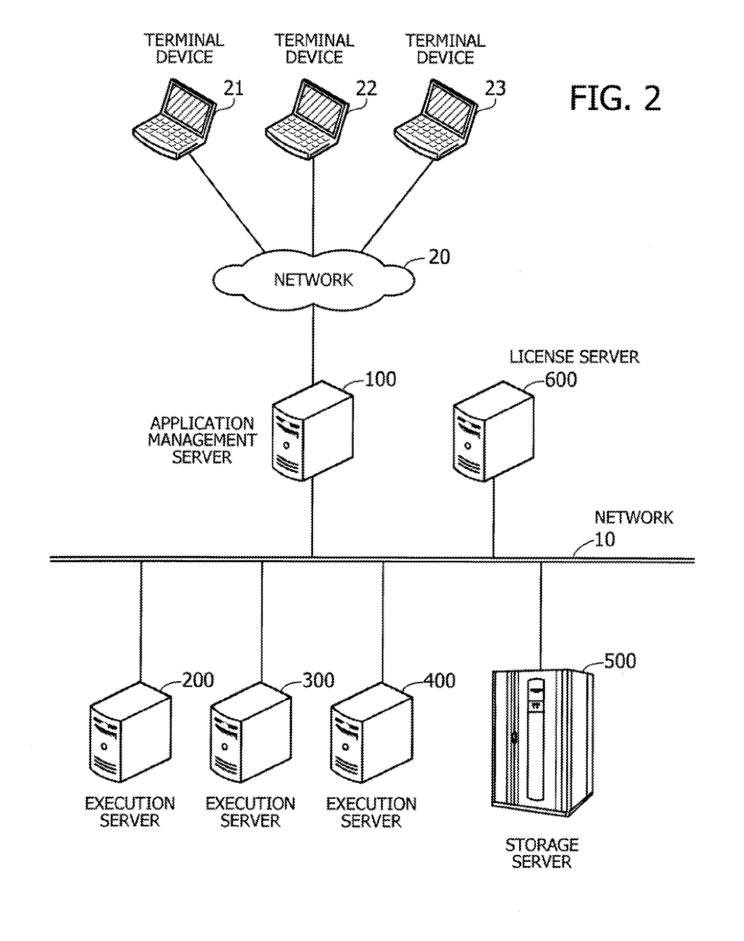

FIG. 2 illustrates an information processing system according to a second embodiment. This information processing system includes a plurality of server computers (simply “servers” where appropriate) to receive requests from terminal devices and execute requested applications. The second embodiment assumes that the information processing system mainly executes design tool applications for electronic circuits such as printed circuit board (PCB) and field programmable gate array (FPGA). However, it is not intended to limit the second embodiment to this specific type of applications. For example, the proposed information processing system may execute applications of other design and development tools such as those for program development or system development.

The information processing system according to the second embodiment includes an application management server 100, execution servers 200, 300, and 400, a storage server 500, and a license server 600. The application management server 100, execution servers 200, 300, and 400, storage server 500, and license server 600 are linked to a network 10. The application management server 100 is also linked to another network 20, as are terminal devices 21, 22, and 23.

The terminal devices 21, 22, and 23 are user computers. The terminal devices 21, 22, and 23 send a request to the application management server 100, thereby requesting one or more applications running (or to be run) on the execution servers 200, 300, and 400 to execute particular processing operations. The processing result is returned from those execution servers 200, 300, and 400 to the requesting terminal devices 21, 22, and 23.

The application management server 100 is a server computer that controls installation and uninstallation of applications on the execution servers 200, 300, and 400. The application management server 100 also accepts requests from terminal devices 21, 22, and 23 and forwards them to the execution servers 200, 300, and 400. When there is a response from the execution servers 200, 300, and 400, the application management server 100 creates data of a display screen for the response and sends it to the requesting terminal devices 21, 22, and 23. The terminal devices 21, 22, and 23 are thus allowed to make applications on the execution servers 200, 300, and 400 execute a desired processing operation with the intervention of the application management server 100.

The execution servers 200, 300, and 400 are server computers that execute applications. It is assumed here that one execution server 200 runs an operating system (OS) referred to as “OS-A” while other two execution servers 300 and 400 run a different operating system “OS-B.” The detailed structure of those operating systems will be described later.

The storage server 500 stores application programs to be installed on the execution servers 200, 300, and 400.

The license server 600 manages the license of applications that may be installed on the execution servers 200, 300, and 400. More specifically, the license server 600 assigns a license from a pool of licenses to a particular execution server 200, 300, and 400 each time an application is installed on that execution server. The license server 600 releases an assigned license from the execution servers 200, 300, and 400 when the corresponding application is uninstalled from them. The license server 600 leaves a log record for each assignment of license and release thereof. By using those log records, the application management server 100 keeps track of the usage of applications on the execution servers 200, 300, and 400.

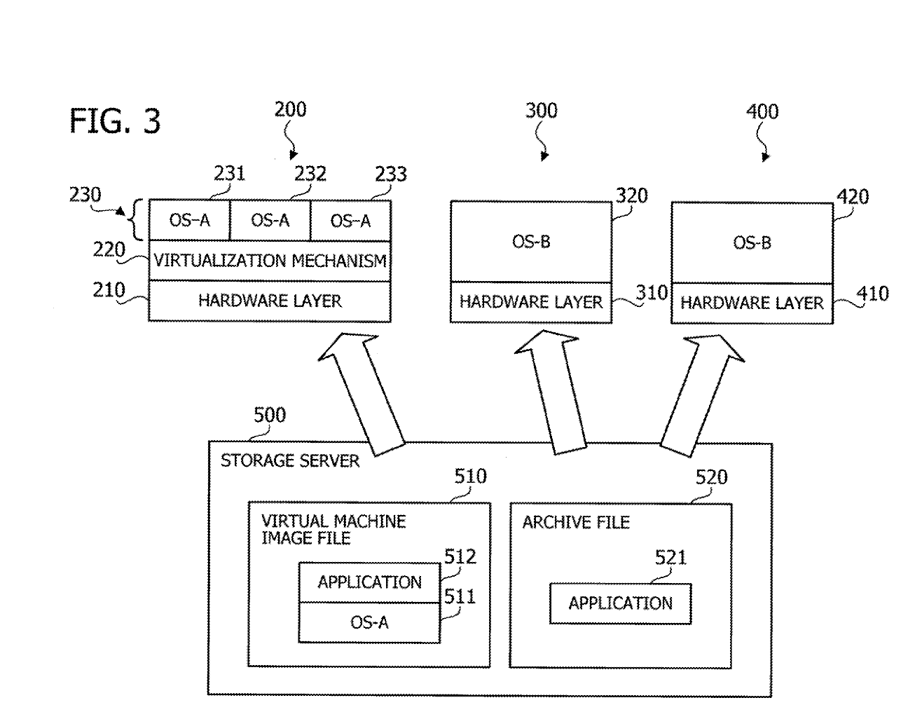

FIG. 3 illustrates a structure of an execution server. The illustrated execution server 200 includes a hardware layer 210, a virtualization mechanism 220, and an OS layer 230. The hardware layer 210 is where hardware resources of the execution server 200 belong. The virtualization mechanism 220 realizes the functions of a plurality of computers virtually on this single execution server 200. More specifically, the virtualization mechanism 220 enables a plurality of operating systems to run on the same execution server 200 and arbitrates device access operations of those operating systems so as to share the resources on the hardware layer 210. The following description uses the term “virtual machines” to refer to such virtual computers on the execution server 200. In contrast, the execution servers 200, 300, and 400 are referred to as “physical machines” since they are physical computers.

The OS layer 230 accommodates a plurality of operating systems (e.g., OSs 231, 232, and 233) realized on the execution server 200 by its virtualization mechanism 220. The OSs 231, 232, and 233 operate independently of each other and provide separate software environments for installing and using applications. The OSs 231, 232, and 233 may be of the same type or different types. FIG. 3 illustrates the case where every OS is “OS-A,” whose versions may, however, be different. For example, “OS-A” is Windows (registered trademark) operating system.

The execution server 300 includes a hardware layer 310 and an OS layer 320. The hardware layer 310 is where hardware resources of the execution server 300 belong. The OS layer 320 is an operating system layer realized on the hardware layer 310. This OS layer 320 accommodates a single operating system (“OS-B”). The execution server 300 has the function of installing and executing applications under that operating system. For example, “OS-B” may be Linux (registered trademark) or UNIX (registered trademark) operating system.

The execution server 400 includes a hardware layer 410 and an OS layer 420. The hardware layer 410 is similar to the foregoing hardware layer 310, and the OS layer 420 is similar to the foregoing OS layer 320.

The storage server 500 stores application programs. Specifically, application programs for the execution server 200 having a virtualization mechanism 220 are stored as computer files, as are those for the other execution servers 300 and 400 having no virtualization mechanisms, the latter and former computer files being configured differently. For example, those computer files may include a virtual machine image file 510 and an archive file 520.

The virtual machine image file 510 contains programs to be installed on the execution server 200. Specifically, the virtual machine image file 510 contains an OS image 511 and an application image 512. The OS image 511 provides a collection of programs for building an operating system on the virtualization mechanism 220. The application image 512 is an image of an application or applications installed on the OS image 511. In other words, the virtual machine image file 510 provides an application image 512 in the state where it is previously installed on the OS image 511. This structure of the virtual machine image file 510 is suitable for the Windows and other operating systems in which the process of installing an application involves updates to OS configuration data, called “registry.” The registry is updated with new or modified entries each time an application is installed on or uninstalled from the existing operating system, and such registry changes may affect the system's operation. The use of a virtual machine image file 510 enables applications to be installed or uninstalled together with the operating system, while ensuring a specific initial state of its registry at the time of starting applications.

On the other hand, the archive file 520 is a computer file containing a program to be installed on execution servers 300 and 400. Specifically, the archive file 520 includes an application file 521 containing application programs and configuration files. The archive file 520 may be used with Linux, UNIX, and other operating systems in which the process of installing an application involves no registry updates. Archive files are managed in the form of, for example, tape archive (TAR) files or TAR Z (TAZ) files. The noted type of operating systems, however, may also use the same installation and uninstallation method as the execution server 200 does with a virtual machine image file containing application programs in addition to an OS image.

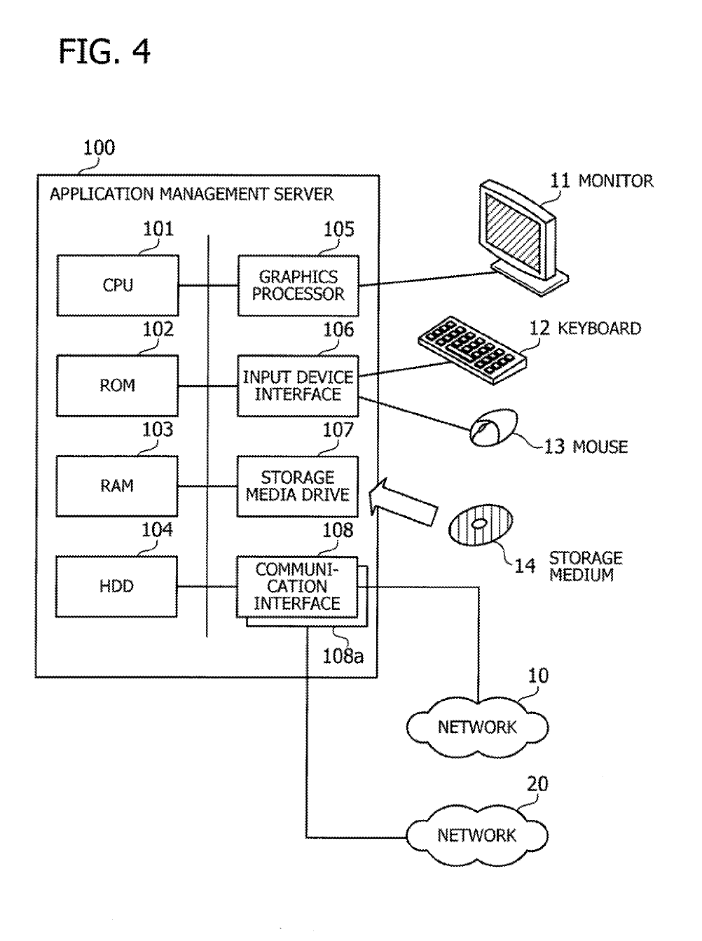

FIG. 4 illustrates a hardware configuration of an application management server. The illustrated application management server 100 includes a central processing unit (CPU) 101, a read only memory (ROM) 102, a random access memory (RAM) 103, a hard disk drive (HDD) 104, a graphics processor 105, an input device interface 106, a storage media drive 107, and communication interfaces 108 and 108a.

The CPU 101 controls the whole of the application management server 100 by executing OS programs and application programs. The ROM 102 stores basic input/output system (BIOS) programs and other programs necessary for starting up the application management server 100. The ROM 102 may be a rewritable non-volatile memory.

The RAM 103 serves as temporary storage for at least part of the OS programs and application programs that the CPU 101 may execute, as well as for various data that the CPU 101 needs to execute the programs. The HDD 104 stores OS programs and application programs, as well as data that the CPU 101 uses to execute the programs. Solid state drives (SSD) or other type of non-volatile storage devices may be used in place of, or together with the HDD 104.

The graphics processor 105, coupled to a monitor 11, produces images in accordance with drawing commands from the CPU 101 and displays them on a screen of the monitor 11. The input device interface 106 is coupled to external input devices such as a keyboard 12 and a mouse 13. The input device interface 106 receives input signals from those input devices and supplies them to the CPU 101.

The storage media drive 107 is a device used to read data in a storage medium 14. This storage medium 14 stores, for example, programs to be executed by the application management server 100. For example, the application management server 100 executes an application management program stored in the storage medium 14, thereby providing application management functions (described later). It is thus possible to distribute programs describing application management processes in the form of a computer-readable storage medium 14.

The above storage medium 14 may be, for example, a magnetic storage device, optical disc, magneto-optical storage medium, or semiconductor memory device. Magnetic storage devices include hard disk drives (HDD), flexible disks (FD), and magnetic tapes, for example. Optical discs include, for example, compact disc (CD), CD-Recordable (CD-R), CD-Rewritable (CD-RW), digital versatile disc (DVD), DVD-R, DVD-RW, and DVD-RAM. Magneto-optical storage media include magneto-optical discs (MO), for example. Semiconductor memory devices include, for example, flash memory such as Universal Serial Bus (USB) flash drives.

The communication interfaces 108 and 108a are connected to networks 10 and 20, respectively. The former communication interface 108 is operable to communicate data with execution servers 200, 300, and 400, storage server 500, and license server 600 via one network 10. The latter communication interface 108a is operable to communicate data with terminal devices 21, 22, and 23 via the other network 20. The aforementioned application management program may be stored in some other server device (not illustrated) on the network 10. When this is the case, the application management server 100 may download and execute programs from this server device.

While FIG. 4 illustrates the application management server 100 alone, the terminal devices 21, 22, and 23, execution servers 200, 300, and 400, storage server 500, and license server 600 may also be implemented with a similar hardware structure.

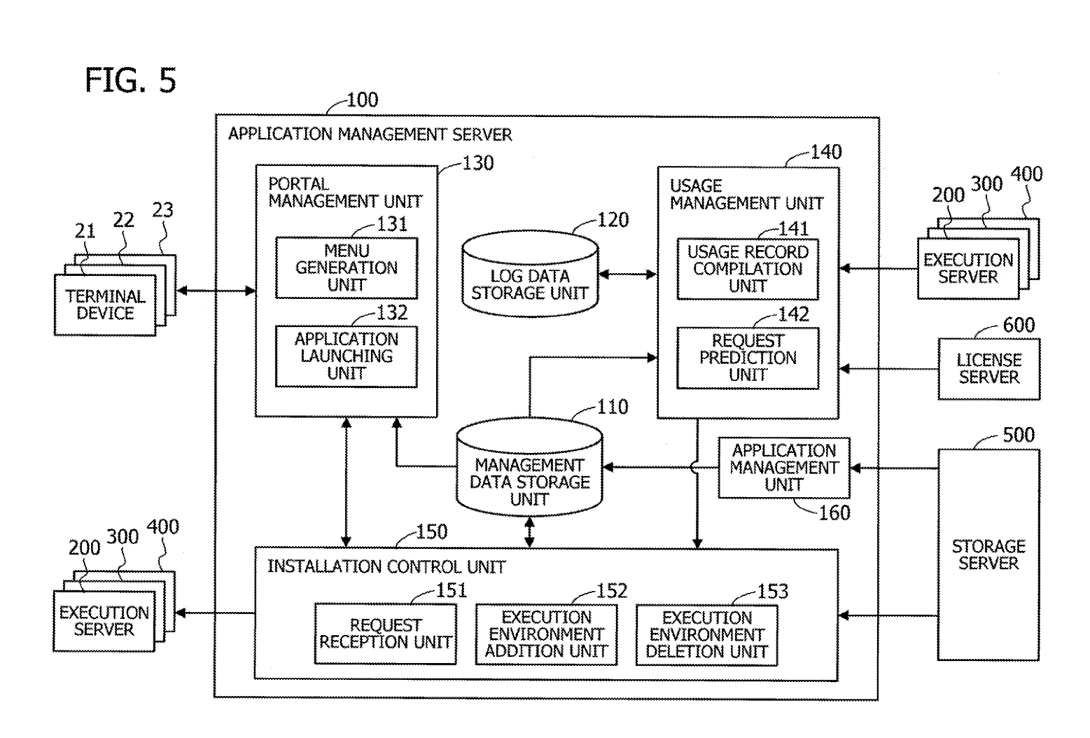

FIG. 5 is a functional block diagram of an application management server. The illustrated application management server 100 includes a management data storage unit 110, a log data storage unit 120, a portal management unit 130, a usage management unit 140, an installation control unit 150, and an application management unit 160. Those functional units are implemented as software on the application management server 100. That is, the CPU 101 executes an application management program to provide their functions. It is noted, however, that all or part of those functions may be implemented as dedicated hardware components.

The management data storage unit 110 stores an application management table to manage applications available to the users. This application management table contains information about each different application, which describes the version, usable operating systems, installation destinations, execution commands for installation, and the like. The management data storage unit 110 also stores design step definition tables describing the use order of applications, i.e., the order in which applications are generally used in each step of a particular design category.

The log data storage unit 120 stores a usage record management table to record the installation status of applications used in each particular design category. This usage record management table may be formed from data fields for storing application name, version, identifiers of destination machines, and the like.

The portal management unit 130 provides the terminal devices 21, 22, and 23 with a portal screen in which the application management server 100 accepts a selection of applications from users. When starting to provide a portal screen for a specific user, the portal management unit 130 performs user authentication by prompting the user to enter his or her own user ID and password. This user authentication process may be performed on a person-to-person basis or on a project-to-project basis. The portal management unit 130 includes a menu generation unit 131 and an application launching unit 132.

The menu generation unit 131 produces a selection screen for design category, application, its version, operating system, and other things and supplies the screen to the terminal devices 21, 22, and 23. An application is selected on the selection screen produced by the menu generation unit 131. The application launching unit 132 receives an install command and a launch command for the selected application. The word “launch” is used to mean the act of bringing an application installed on one or more execution servers 200, 300, and 400 into an execution state. When an install command is received, the application launching unit 132 forwards the command to the installation control unit 150. When a launch command is received, the application launching unit 132 launches an installed application on relevant execution servers 200, 300, and 400.

The usage management unit 140 manages usage of applications installed on execution servers 200, 300, and 400. To this end, the usage management unit 140 includes a usage record compilation unit 141 and a request prediction unit 142 described below.

The usage record compilation unit 141 consults the license server 600 to obtain information about how the licenses of applications are assigned to execution servers 200, 300, and 400. The usage record compilation unit 141 also consults the execution servers 200, 300, and 400 to obtain more specific usage information, such as which user is using a particular application, and how long time it is. The usage record compilation unit 141 compiles the obtained information into a usage record management table in the log data storage unit 120.

The request prediction unit 142 predicts which application will subsequently be requested by terminal devices 21, 22, and 23, with reference to the design step definition tables stored in the management data storage unit 110, as well as to the usage record management table stored in the log data storage unit 120. The request prediction unit 142 then sends an install command to the installation control unit 150 to initiate installation of the predicted application.

The installation control unit 150 controls installation and uninstallation of applications on the execution servers 200, 300, and 400. To this end, the installation control unit 150 includes a request reception unit 151, an execution environment addition unit 152, and an execution environment deletion unit 153 described below.

The request reception unit 151 receives an install command from the application launching unit 132 or request prediction unit 142. In response to this command, the request reception unit 151 determines on which server the requested application is to be installed, with reference to the application management table in the management data storage unit 110. The request reception unit 151 then informs the execution environment addition unit 152 of the determined server.

The execution environment addition unit 152 installs a specified application on specified execution servers 200, 300, and 400, with reference to the application management table stored in the management data storage unit 110. For example, when installing an application on an OS-A environment, the execution environment addition unit 152 causes an execution server 200 to execute a virtual machine image file 510. This action permits the specified application to be installed together with an operating system “OS-A” on the execution server 200. When installing an application on an OS-B environment, the execution environment addition unit 152 causes an execution server 300 or 400 to copy and expand (decompress) an archive file 520 in a specific directory. This action permits the specified application to be installed on the execution server 300 or 400.

The execution environment deletion unit 153 commands uninstallation of an application from execution servers 200, 300, and 400. More specifically, the execution environment deletion unit 153 determines which application to uninstall, based on the load condition of execution servers 200, 300, and 400 or of virtual machines running on the execution server 200.

The application management unit 160 populates the application management table in the management data storage unit 110 with information about application programs stored in the storage server 500. When a new application program is added to the storage server 500 by a system administrator, the application management unit 160 allows the administrator to update the application management table in the management data storage unit 110 to reflect the information on that new application program.

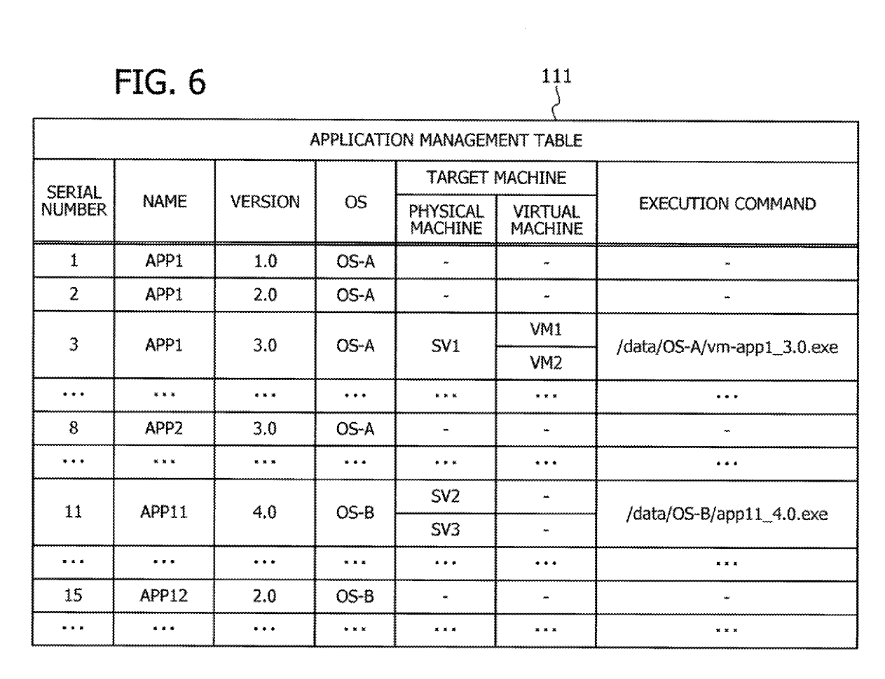

FIG. 6 illustrates an example data structure of the application management table. The illustrated application management table 111 is stored in the management data storage unit 110. Specifically, the application management table 111 is formed from a plurality of data fields titled as follows: “Serial Number,” “Name,” “Version,” “OS,” “Target Machine,” and “Execution Command.” The data values horizontally arranged in this application management table 111 are associated with each other to constitute a single record of managed data. The serial number field contains an identification number to distinguish each record from others. The name field indicates the name of an application, and the version field indicates the version of that application. The OS field indicates the name of an operating system. The target machine field contains information for identifying a target machine on which the application is to be installed. This target machine field is divided into two subfields titled “Physical Machine” and “Virtual Machine.” The physical machine subfield contains information specifying an execution server 200, 300, or 400. The virtual machine subfield contains information identifying a specific virtual machine. The execution command field indicates a command that will be used to execute the corresponding application.

For example, the illustrated application management table 111 contains a record formed from a serial number of “1,” name of “APP1,” version of “1.0,” OS of “OS-A,” target physical machine of “-” (hyphen), target virtual machine of “-,” and execution command of “-.” This record means that an application program APP1 version 1.0 adapted for operating system OS-A has been stored in the storage server 500. The hyphens (-) in the target machine and execution command fields indicate that no data is in those data fields, meaning that the application APP1 has not yet been installed on any servers.

For another example, the illustrated application management table 111 contains a record formed from a serial number of “3,” name of “APP1,” version of “3.0,” OS of “OS-A,” target physical machine of “SV1,” target virtual machines of “VM1” and “VM2,” and execution command of “/data/OS-A/vm-app1_{—}3.0.exe.” This record means that an application program APP1 version 3.0 adapted for operating system OS-A has been stored in the storage server 500. The same record also indicates that the application has already been installed on one execution server 200 identified as physical machine SV1. The record further indicates that the application has been installed on two virtual machines VM1 and VM2. The execution command “/data/OS-A/vm-app1_{—}3.0.exe” may be executed on each of those virtual machines to bring the application APP1 version 3.0 into an execution state.

For yet another example, the illustrated application management table 111 contains a record formed from a serial number of “11,” name of “APP11,” version of “4.0,” OS of “OS-B,” target physical machines of “SV2” and “SV3,” target virtual machine of “-,” and execution command of “/data/OS-B/app11_{—}4.0.exe.” This record means that an application program APP11 version 4.0 adapted for operating system OS-B has been stored in the storage server 500. The same record also indicates that the application has already been installed on two execution servers 300 and 400 identified as physical machines SV2 and SV3, respectively. Since there are no virtual machines on the execution servers 300 and 400, the virtual machine subfield contains “-” (i.e., left empty). The execution command “/data/OS-B/app11_{—}4.0.exe” may be executed on each of those virtual machines to bring the application APP11 version 4.0 into an execution state.

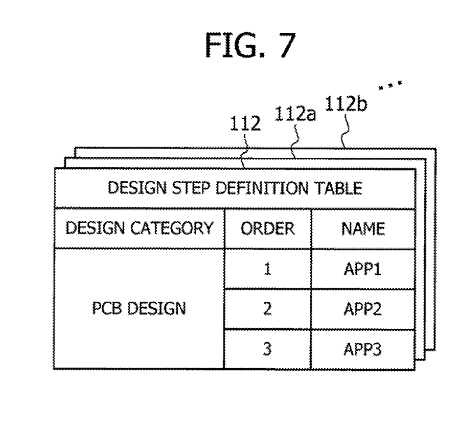

FIG. 7 illustrates an example data structure of design step definition tables. These design step definition tables 112, 112a, 112b, . . . are stored in the management data storage unit 110. The following section will describe the data structure of one design step definition table 112. The same description applies to other design step definition tables 112a, 112b, . . . as well.

The design step definition table 112 is formed from a plurality of data fields titles “Design Category,” “Order,” and “Name.” The data values horizontally arranged in this design step definition table 112 are associated with each other to constitute a single record of managed data. The design category field contains the name of a specific design tool suite. The order field contains a series of numbers to indicate the order in which the applications are to be used. The name field contains the name of each application.

For example, the illustrated design step definition table 112 contains a record with a design category of “PCB Design,” order of “1,” and name of “APP1.” This record first means that the design step definition table 112 provides definition information about PCB design. The order field value of “1” indicates that the application APP1 is supposed to be executed in the first place. Similarly the order field value of “2” indicates that the application APP2 is supposed to be executed subsequently to the order “1” application. The order field value of “3” indicates that the application APP3 is supposed to be executed subsequently to the order “2” application. While not seen in FIG. 7, other order field values “4,” “5,” . . . are interpreted in a similar way.

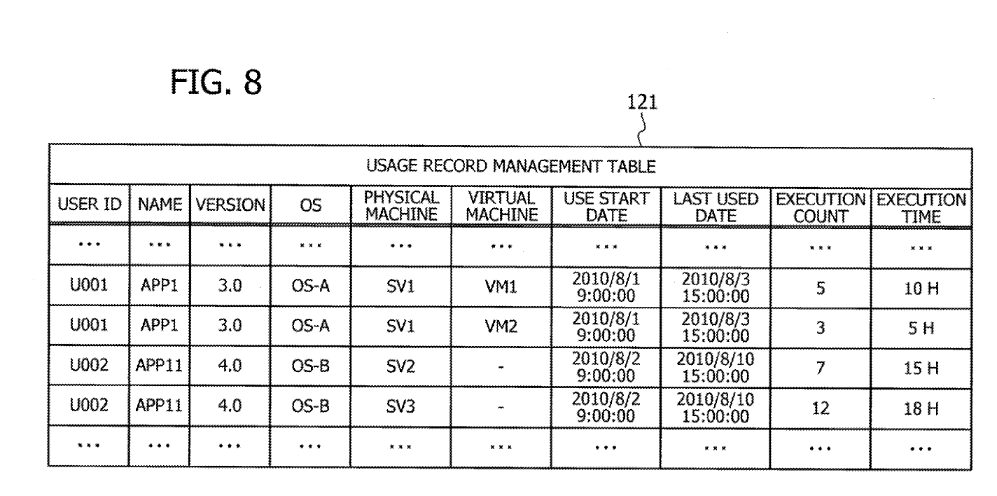

FIG. 8 illustrates an example data structure of a usage record management table. The usage record management table 121 is stored in the log data storage unit 120. The usage record management table 121 is formed from a plurality of data fields titled as follows: “User ID” (User Identifier), “Name,” “Version,” “OS,” “Physical Machine,” “Virtual Machine,” “Use Start Date,” “Last Used Date,” “Execution Count,” and “Execution Time.” The data values horizontally arranged in this usage record management table 121 are associated with each other to constitute a single usage track record.

The user ID field contains an identifier identifying a specific user. The name field contains the name of an application and the version field indicates the version of that application. The OS field indicates the name of an operating system. The physical machine field contains information specifying an execution server 200, 300, or 400. The virtual machine subfield contains information identifying a specific virtual machine. The use start date field indicates the date and time when the application started to be used. The last used date field indicates the date and time when the application was last closed. The execution count field indicates how many times the application was executed during a predetermined period (e.g., the recent one week). The execution time field indicates how long time the application was executed during a predetermined period (e.g., the recent one week).

For example, the illustrated usage record management table 121 contains a usage track record with a user ID of “U001,” name of “APP1,” version of “3.0,” OS of “OS-A,” physical machine of “SV1,” virtual machine of “VM1,” use start date of “2010/8/1 9:00:00,” last used date of “2010/8/3 15:00:00,” execution count of “5,” and execution time of “10 H” (hours). This record indicates that one user identified by user ID “U001” launched application APP1 version 3.0. This application APP1 was installed on virtual machine VM1 under operating system “OS-A,” which was built on a physical machine SV1, or the execution server 200. The use of application APP1 started at 9:00:00 AM on Aug. 1, 2010 and ended at 3:00:00 PM on Aug. 3, 2010. Further, the noted record indicates that the application was executed five times and for ten hours during the predetermined period.

For another example, the usage record management table 121 contains a usage track record with a user ID of “U002,” name of “APP11,” version of “4.0,” OS of “OS-B,” physical machine of “SV2,” virtual machine of “-,” use start date of “2010/8/2 9:00:00,” last used date of “2010/8/10 15:00:00,” execution count of “7,” and execution time of “15 H.” This record indicates that another user identified by user ID “U002” used application APP11 version 4.0. This application APP11 was installed under operating system “OS-B” on physical machine SV2, or the execution server 300. The use of application APP11 started at 9:00:00 AM on Aug. 2, 2010 and ended at 3:00:00 PM on Aug. 10, 2010. Further, the noted record indicates that the application was executed seven times and for fifteen hours during the predetermined period.

Each time an application is launched on the execution servers 200, 300, and 400 upon request from users, its record is placed in a log. Similarly, each time the license server 600 allocates a license of applications, its record is placed in a license allocation log (not illustrated). By consulting the application launch log of each user, as well as the license allocation log, the usage record compilation unit 141 obtains information for populating each field of the usage record management table 121.

For example, the usage record compilation unit 141 collects log records indicating start and stop of applications on the execution server 200. Such log records are produced by a plurality of “OS-A” operating systems running on the execution server 200, and the usage record compilation unit 141 collects such records for each different virtual machine. Then, out of the collected log records of started and stopped applications, the usage record compilation unit 141 obtains the use start date, last used date, execution count, and execution time of a particular application APP1. More specifically, the use start date is obtained as the date and time when the application APP1 was launched for the first time. The last used date is obtained as the date and time when the application APP1 was last closed. The execution count is obtained as the number of launching events occurred during the predetermined period. The execution time is obtained as the accumulated time of execution during the predetermined period.

The use start date may, however, alternatively be obtained from a license allocation log of the license server 600. That is, the log records of license allocation indicate when each license was allocated from the license server 600 to the execution servers 200, 300, and 400. The usage record compilation unit 141 thus uses this information to obtain the use start date of an application.

Each piece of the above-noted information may be collected from a similar log that is produced by the application “APP1” itself. The usage record compilation unit 141 similarly obtains execution counts and execution times of APP11 and other applications by collecting log records indicating start and stop of the applications. Those log records are produced by operating system OS-B on the execution servers 300 and 400 or by the applications themselves.

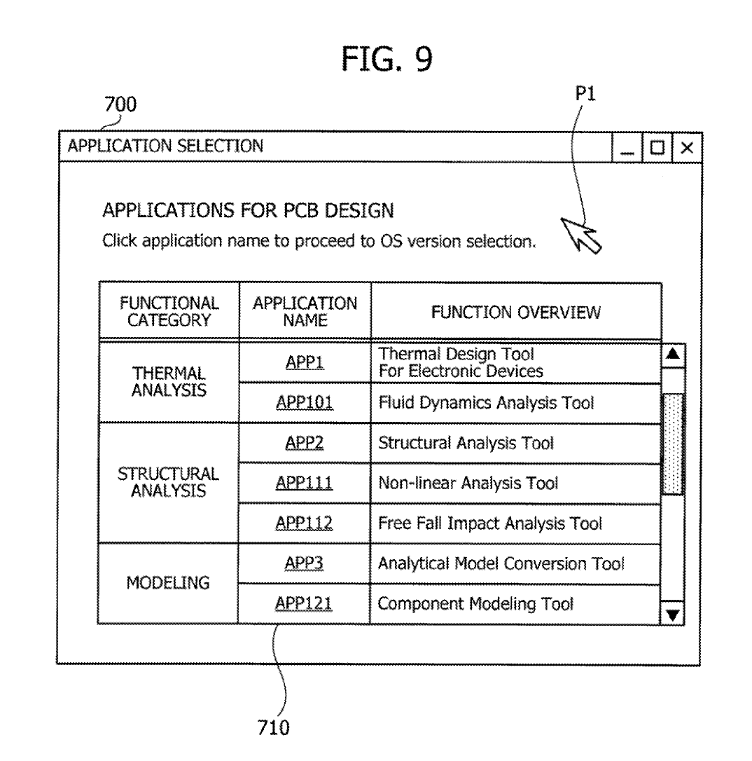

FIG. 9 illustrates an example of an application selection screen. The menu generation unit 131 produces an application selection screen 700 for each design category and sends it to terminal devices 21, 22, and 23. Before doing so, the menu generation unit 131 may provide a menu screen (not illustrated) containing a list of design categories, in which the user is prompted to select a specific design category. The menu generation unit 131 then produces an application selection screen 700 for the selected design category. The illustrated application selection screen 700 appears when the user selects PCB design. The application selection screen 700 has an application list box 710.

The application list box 710 gives a list of applications that the information processing system offers. For example, the application list box 710 is formed from the following information fields: “Functional Category,” “Application Name,” and “Function Overview.” The application names are selectable through the use of pointer P1. The users are allowed to select a desired application by placing the pointer P1 and clicking its name with their pointing device attached to the terminal devices 21, 22, and 23. In response to the user's selection, the menu generation unit 131 produces a version selection screen on the basis of a link that is embedded in the selected application name.

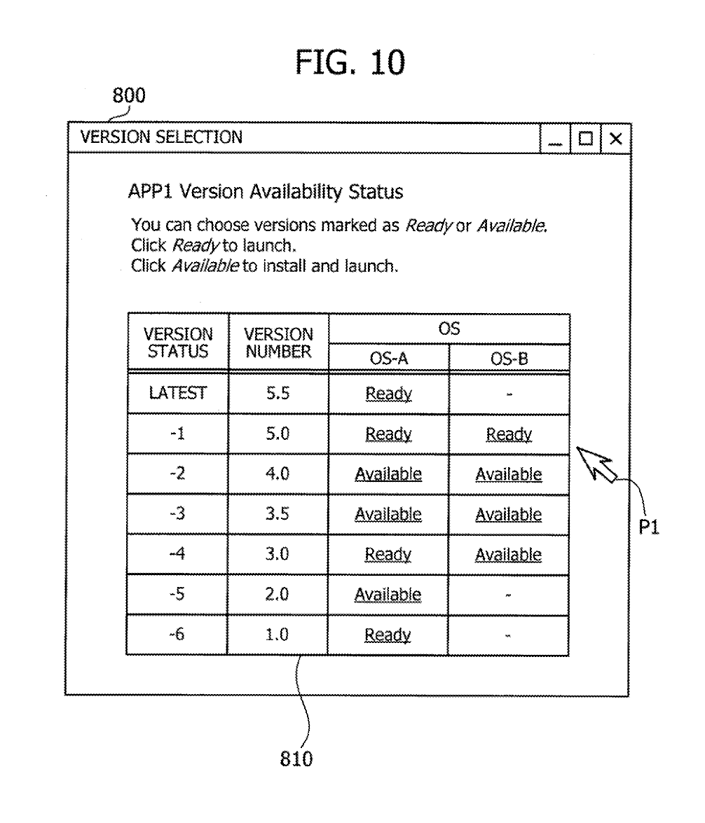

FIG. 10 illustrates an example of a version selection screen. This version selection screen 800 is produced by the menu generation unit 131 and supplied to the terminal devices 21, 22, and 23. The version selection screen 800 has a version list box 810.

The version list box 810 gives a list of available versions of a particular application that has been selected in the application selection screen 700. Specifically, the version list box 810 is formed from the following information fields: “Version Status,” “Version Number,” and “OS.”

The version status field indicates the update status of each version. For example, the version status field indicates “LATEST” for the newest version. Status “-1” means one version before the latest. Status “-2” means two versions before the latest, which is followed by status “-3” and subsequent versions in a similar way.

The version number field contains numerals representing a specific version of the application. The OS field contains some text or symbols indicating on which operating system the application is provided. In the example of FIG. 10, the indicators include “Ready,” “Available,” and “-” (hyphen).

Indicator “Ready” denotes that the version has already been installed on one or more of the execution servers 200, 300, and 400. Indicator “Available” denotes that the version is not installed on any execution servers 200, 300, and 400, but will be available for use after installation. The hyphen, on the other hand, indicates that the application of that version does not run on the operating system in question and thus unavailable for use.

The former two indicators “Ready” and “Available” are selectable through the use of pointer P1. That is, the users are allowed to select a desired version by placing the pointer P1 and clicking it with their pointing device attached to the terminal devices 21, 22, and 23. When an indicator “Ready” is selected, the application launching unit 132 commands a relevant execution server 200, 300, or 400 to launch the corresponding version of the application. When an indicator “Available” is selected, the application launching unit 132 sends an install command to the installation control unit 150 to initiate installation of the corresponding version of the application. Then upon receipt of an installation completion notice from the installation control unit 150, the application launching unit 132 commands the relevant execution server 200, 300, or 400 to launch the newly installed version of the application.

As can be seen from the above, the versions marked “Ready” need no extra time for installation, as opposed to those marked “Available.” In other words, the application is readily available to users.

While the second embodiment offers two choices of operating system, “OS-A” and “OS-B,” it is possible to provide three or more choices. For example, the menu generation unit 131 expands the OS field of the version list box 810 to indicate the availability status of more operating systems such as “OS-C,” “OS-D,” and so on. In the case where the same operating system has several different versions, the menu generation unit 131 may include those versions as part of the choices. In the case, for example, where the operating system “OS-A” has a plurality of versions, the menu generation unit 131 divides the OS-A field of the version list box 810 into smaller subfields to indicate the availability status of each version.

While the above-described version selection screen presents installed applications and non-installed applications in a distinguishable way, there may be other ways to implement such distinctions. For example, installed applications may be displayed in a particular color (e.g., blue) while non-installed applications are displayed in a paler color (e.g., gray).

As can be seen from the above, the user selects a particular operating system and its version number when starting to use a development tool. This selection is necessary for the reasons described below. Suppose, for example, that the user is developing an improved version of an existing circuit by reusing design data of the latter circuit. First, it is inefficient in this case to use different versions of development tools on different operating systems because those differences often mean different user interfaces. Second, the design data may not be compatible between different versions or different operating systems.

Development tools may be updated to new versions at certain intervals (e.g., once to four times a year). The storage server 500 thus is ready to provide a plurality of versions of each development tool, taking development cycles into consideration. For example, recent ten versions (i.e., the latest version to -9 version) may preferably be prepared in the storage server 500.

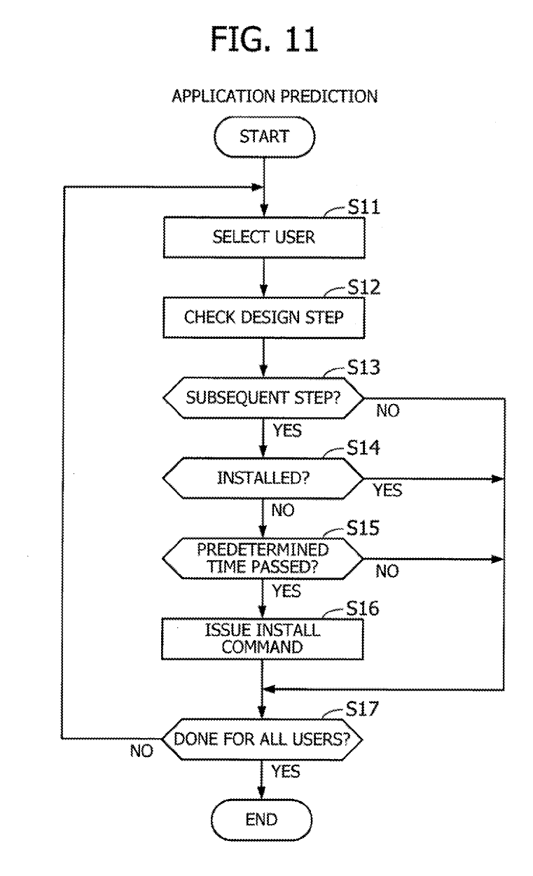

The application management server 100 performs above-described functions through a procedure described below. FIG. 11 is a flowchart of an application prediction process according to the second embodiment. Each step of FIG. 11 will now be described below in the order of step numbers.

(S11) The request prediction unit 142 selects a user who is using an application, by consulting the usage record management table 121 stored in the log data storage unit 120. For example, the execution count field of this usage record management table 121 indicates whether the user is using an application. More specifically, if a certain record contains a value greater than zero in its execution count field, it means that the corresponding user is using an application during a predetermined length (e.g., one week) of period including the present. If the execution count field indicates zero in a certain record, then the corresponding application is not being used.

(S12) The request prediction unit 142 determines in which design step in the current design category the user selected at step S11 is engaged. More specifically, the request prediction unit 142 consults the usage record management table 121 to determine the application name and version associated with the selected user. For example, the request prediction unit 142 obtains an application name of “APP1” associated with user ID “U001” in the usage record management table 121.

(S13) Using the obtained application name as a keyword, the request prediction unit 142 searches a relevant design step definition table 112, 112a, 112b, . . . in the management data storage unit 110, thus determining whether there is any step that follows the current step. If there exists a subsequent step, the process advances to step S14. If there are no subsequent steps, the process skips to step S17. For example, the request prediction unit 142 examines a design step definition table 112 for PCB design and finds that the application APP1 is placed at the topmost order (“1”). The request prediction unit 142 also finds that there is another application APP2 in the next order (“2”). The request prediction unit 142 determines that there are no subsequent steps, when the last step defined in the relevant design step definition table 112, 112a, 112b, is found to be the current design step. For example, in the design step definition table 112, application APP3 is the last step followed by no other applications.

(S14) The request prediction unit 142 determines which version to select for the subsequent-step application found at step S13. More specifically, the request prediction unit 142 may select the same version as the current-step application determined at step S12. With reference to the application management table 111 stored in the management data storage unit 110, the request prediction unit 142 determines whether the selected version of the subsequent-step application has already been installed. If it is not installed, the process advances to step S15. If it has been installed, the process skips to step S17. It is noted here that there may be two or more instances of the application used in the current step. When this is the case, the request prediction unit 142 determines whether the same number of instances have been installed for the subsequent-step application. If there is a shortage in the installed instances, the request prediction unit 142 advances the process to step S15 with the number of such missing instances.

(S15) With reference to the usage record management table 121 stored in the log data storage unit 120, the request prediction unit 142 determines whether a predetermined time T has passed since the use start date when the currently selected user started the current-step application. If that time has passed, the process advances to step S16. If not, the process skips to step S17. The value of time T may be determined as necessary, depending on the system's operational conditions. T may be set to zero to install next applications immediately after the user starts to use the current one.

(S16) The request prediction unit 142 issues an install command to the installation control unit 150 for the subsequent-step application identified at step S13. This install command contains information specifying OS, application, version, and additional application quantity. The request prediction unit 142 may obtain those pieces of information from the application management table 111. The “additional application quantity” denotes the number of application instances to be added, which are determined as missing at step S14.

(S17) The request prediction unit 142 determines whether the above processing has been done for all users. If it has, then the process is terminated. If there are remaining users, the process returns to step S11 after finalizing the processing for the currently selected user.

With the process described above, the request prediction unit 142 determines which application will be used next to the current one, by consulting design step definition tables 112, 112a, 112b, . . . , and issues an install command for the determined application. The request prediction unit 142 is designed to control when to issue an install command for the subsequent application, based on the use start date on which the user started the current application. This feature of the request prediction unit 142 reduces the duration in which the next application is installed, but not actually used by the user.

The value of time T used at step S15 may vary from application to application. That is, the subsequent-step application may have a different value of T from the current-step application. Or, different values of T may be assigned to different combinations of successive applications. Those values of T may then be stored in the management data storage unit 110. This feature makes it possible to control the installation timing of applications, taking into consideration the difference in time duration between development steps. The above-described application prediction process may be invoked upon detection of a newly started application, such that the subsequent-step application will be installed immediately after the current-step application is started.

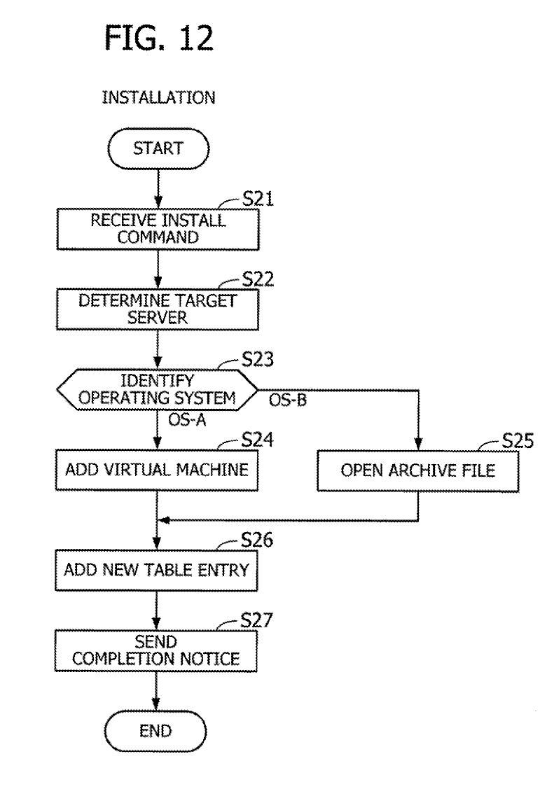

FIG. 12 is a flowchart of an installation process. Each step of FIG. 12 will now be described below in the order of step numbers.

(S21) The request reception unit 151 receives an install command from the request prediction unit 142.

(S22) The request reception unit 151 determines on which server the requested application is to be installed, with reference to an application management table 111 in the management data storage unit 110. Suppose, for example, that the install command specifies application APP2 version 3.0 for operating system OS-A. The request reception unit 151 chooses an execution server 200 as the target server since the specified operating system OS-A is available on that server. The request reception unit 151 then outputs the install command to the execution environment addition unit 152, together with information specifying the target server on which the application is to be installed. However, in the case where the installation command specifies operating system OS-B, there are a plurality of execution servers capable of providing that operating system. In this case, load distribution may be achieved by using those execution servers as target machines. For example, the request reception unit 151 may collect information on the current CPU load, the number of installed applications, and the like from each execution server. The request reception unit 151 then determines target machines such that those load factors are equalized across them.

(S23) Upon receipt of the install command from the request reception unit 151, the execution environment addition unit 152 determines on which operating system to install the requested application. If it is OS-A, the process advances to step S24. If it is OS-B, the process advances to step S25.

(S24) The execution environment addition unit 152 consults the storage server 500 to retrieve a virtual machine image file 510 for the requested application. With this virtual machine image file 510, the execution environment addition unit 152 adds an OS-A environment to the execution server 200. For example, when the install command specifies application APP2 version 3.0, the execution environment addition unit 152 adds an OS-A environment including application APP2 version 2.0 to the execution server 200, thus installing APP2 version 2.0 on a virtual machine on the execution server 200. It is noted that the newly added operating OS-A is in the execution state from the very moment when it is installed.

(S25) The execution environment addition unit 152 consults the storage server 500 to retrieve an archive file 520 for the requested application. The execution environment addition unit 152 expands the retrieved archive file 520 on the execution servers 300 and 400, thereby installing the specified version of the application on the execution server 300 or 400.

(S26) The execution environment addition unit 152 updates the application management table 111 to register information on the newly installed application. Newly created virtual machines, if any, need their identifiers. The execution environment addition unit 152 may create identifiers by incrementing an existing identifier. The execution environment addition unit 152 also produces an execution command for executing the added application.

(S27) The execution environment addition unit 152 sends a completion notice to inform the portal management unit 130 of completion of the installation.

With the above-described process, the request reception unit 151 and execution environment addition unit 152 select a specific target machine and install an application on the selected target machine.

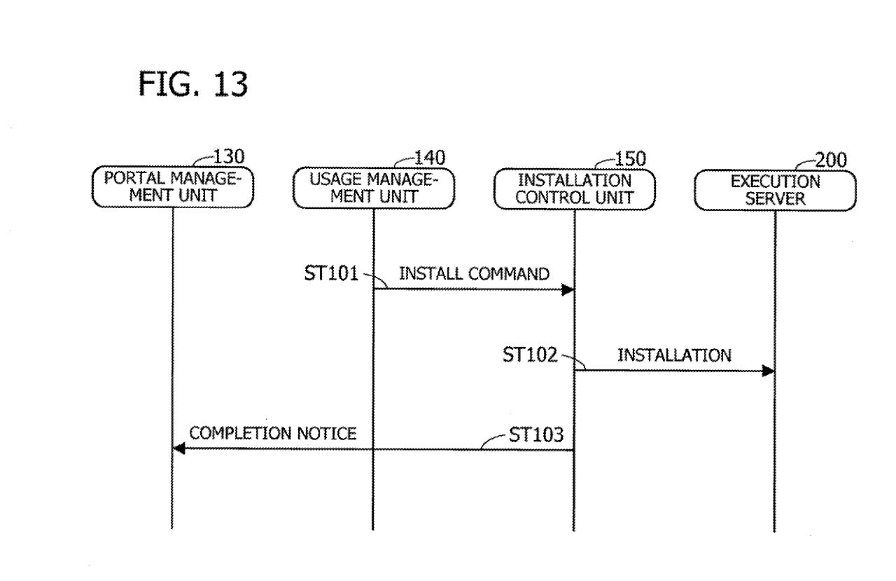

FIG. 13 is a sequence diagram illustrating how an installation process is executed. Each step of this FIG. 13 will now be described below in the order of step numbers. While FIG. 13 exemplifies interaction with one execution server 200 for illustrative purposes, the sequence diagram may similarly apply to other execution servers 300 and 400.

(ST101) The usage management unit 140 executes application prediction at predetermined intervals, whose detailed process has been described in FIG. 11. As a result, the usage management unit 140 sends an install command to the installation control unit 150 to initiate installation of application APP2 version 2.0. The installation control unit 150 accepts this install command.

(ST102) Based on the received install command, the installation control unit 150 installs application APP2 version 2.0 on the execution server 200 in the way discussed in FIG. 12. Upon completion of this installation, the installation control unit 150 updates the application management table 111 in the management data storage unit 110 to register information on the installed application APP2.

(ST103) The installation control unit 150 outputs a completion notice to inform the portal management unit 130 of completion of the installation. Upon receipt of this completion notice, the portal management unit 130 consults the application management table 111 to include its updated content in a version selection screen 800 when it is subsequently produced. More specifically, the menu generation unit 131 will change the indication for the newly installed application APP2 version 2.0, from “Available” to “Ready,” in the version list box 810.

As can be seen from the above, the application management server 100 is designed to predict which applications will be requested by terminal devices 21, 22, and 23 and previously install the expected applications on the execution servers 200, 300, and 400. This feature permits the users to proceed from the current development step to the next development step by immediately launching necessary applications, without the need for spending their time for installation.

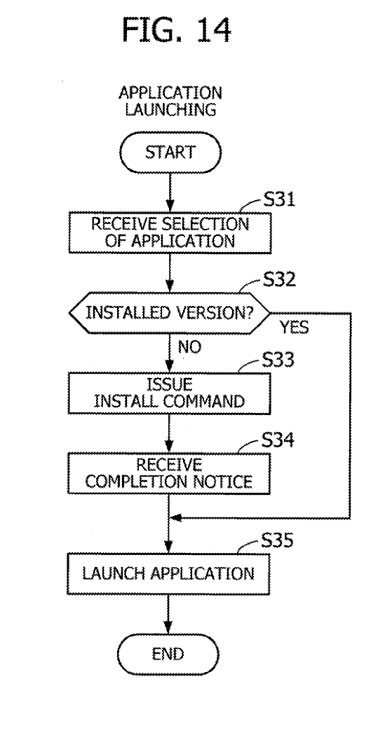

FIG. 14 is a flowchart of an application launching process. Each step of FIG. 14 will now be described below in the order of step numbers.

(S31) The menu generation unit 131 produces a version selection screen 800 for a specific application and supplies it to terminal devices 21, 22, and 23. From one of those terminal devices 21, 22, and 23, the application launching unit 132 receives a user input that specifies a particular version of the application selected out of those listed in the version selection screen 800. Here the menu generation unit 131 consults the application management table 111 in the management data storage unit 110 to see which versions of the application have been installed. The management data storage unit 110 then marks installed versions as “Ready” and non-installed versions as “Available” in the version list box 810.

(S32) The application launching unit 132 determines whether the user has selected an installed version of the application or a non-installed version of the application. In the latter case, the process advances to step S33. In the former case, the process skips to step S35.

(S33) The application launching unit 132 issues an install command to the installation control unit 150 to initiate installation of the selected version of the application. This install command contains information specifying OS, application, version, and additional application quantity. The additional application quantity is set to, for example, one application per selection. In this regard, the menu generation unit 131 may include an input form in the version selection screen 800 to allow the user to enter the number of instances of the application. In response to the above install command, the installation control unit 150 performs an installation process in the way described in FIG. 12.

(S34) The application launching unit 132 receives a completion notice from the installation control unit 150. Besides indicating that the installation of the application has been finished, this completion notice includes an execution command for executing the added application.

(S35) With reference to the application management table 111, the application launching unit 132 identifies on which execution server the selected version of the application has been installed. The application launching unit 132 then sends an execution command to the identified execution server. The requested execution server executes the execution command, thus launching the specified application. In the case where the application is installed on a plurality of execution servers, the application launching unit 132 may specify two or more such servers to distribute the processing load. For example, the application launching unit 132 may collect information on the current CPU load, the number of installed applications, and the like from each execution server. The application launching unit 132 then determines execution servers such that those load factors are equalized across them.

With the above-described processing, the application launching unit 132 causes appropriate execution servers 200, 300, and 400 to launch a user-specified application. The following section will now describe a more specific example of how applications are launched. Suppose first the case in which the selected application is already installed on an execution server 200.

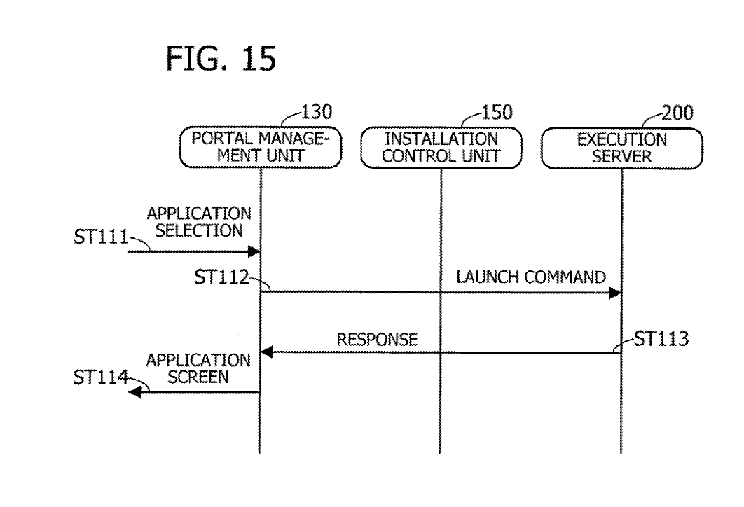

FIG. 15 is a first sequence diagram illustrating how an application launching process is executed. Each step of FIG. 15 will be described below in the order of step numbers.

(ST111) It is assumed here that a version selection screen 800 has been provided from the portal management unit 130 to a terminal device 21. Specifically, its version list box 810 indicates application APP1 version 5.0 as “Ready” on operating system OS-A. The portal management unit 130 receives information from the terminal device 21 which indicates selection of this application APP1 version 5.0 on OS-A.

(ST112) The portal management unit 130 sends a launch command to the execution server 200, including therein an execution command for application APP1 version 5.0 on OS-A. In response, the execution server 200 launches the requested application according to the execution command.

(ST113) When the requested application APP1 version 5.0 is successfully launched, the execution server 200 so notifies the portal management unit 130 by returning a response indicating the launching result. The portal management unit 130 receives this response from the execution server 200.

(ST114) The portal management unit 130 produces a screen for the user to operate application APP2 version 2.0 and sends it to the terminal device 21. The user interacts with this screen on the terminal device 21, the content of which is sent from the terminal device 21 to the execution server 200 via the application management server 100. According to this input, the execution server 200 executes processing and returns the result back to the terminal device 21 via the application management server 100.

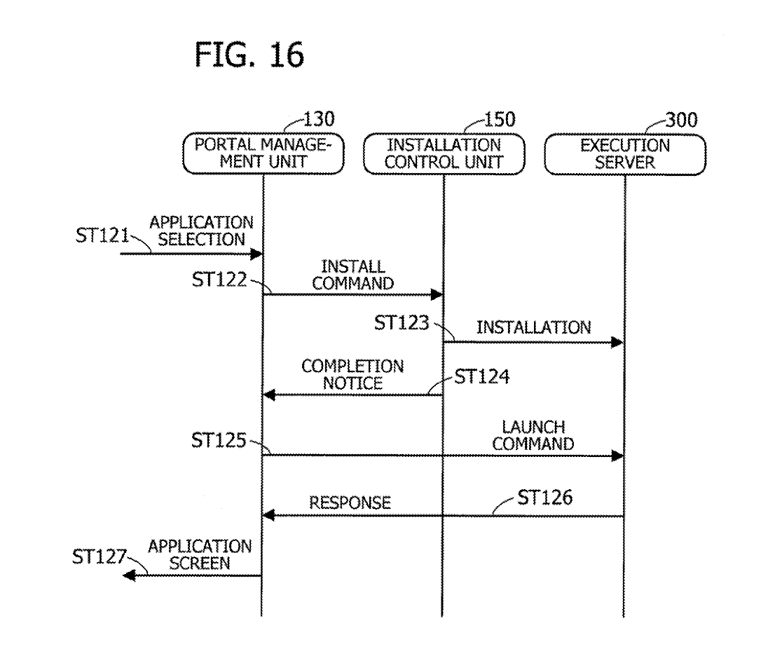

In the case where the selected application is not yet installed in execution servers 300 and 400, the application management server 100 operates as follows. FIG. 16 is a second sequence diagram illustrating how an application launching process is executed. Each step of FIG. 16 will be described below in the order of step numbers.

(ST121) It is assumed here that a version selection screen 800 has been provided from the portal management unit 130 to a terminal device 21. Specifically, its version list box 810 indicates application APP1 version 4.0 as “Available” for use on operating system OS-B, meaning that it is not installed, but available for selection. The portal management unit 130 receives information from the terminal device 21 which indicates selection of this application APP1 version 4.0 on OS-B.

(ST122) The portal management unit 130 issues an install command to the installation control unit 150 to install application APP1 version 4.0 on OS-B. The installation control unit 150 accepts this install command from the portal management unit 130.

(ST123) Based on the install command, the installation control unit 150 selects, for example, an execution server 300 as the target server and installs application APP1 version 4.0 on the selected execution server 300 in the way discussed in FIG. 12. Upon completion of the installation, the installation control unit 150 updates the application management table 111 in the management data storage unit 110 to register information on the installed application APP1.

(ST124) The installation control unit 150 outputs a completion notice to inform the portal management unit 130 of completion of the installation. Upon receipt of this completion notice, the portal management unit 130 consults the application management table 111 to include its updated content in a version selection screen 800 when it is subsequently produced. More specifically, the menu generation unit 131 changes the indication for the newly installed application APP1 version 4.0 from “Available” to “Ready” in the version list box 810.

(ST125) Upon receipt of the completion notice, the portal management unit 130 sends a launch command to the execution server 300, including therein an execution command for application APP1 version 4.0. In response, the execution server 300 launches the requested application according to the execution command.

(ST126) When the application APP1 version 4.0 is successfully launched, the execution server 300 so notifies the portal management unit 130 by returning a response indicating the launching result. The portal management unit 130 receives this response from the execution server 300.

(ST127) The portal management unit 130 produces a screen for the user to operate application APP1 version 4.0 and sends it to the terminal device 21.

With the above-described processing, the application management server 100 causes appropriate execution servers 200, 300, and 400 to launch a user-specified application. The application management server 100 then creates and sends an application screen to the requesting terminal device 21, 22, or 23, so that the user may interact with the installed application

While the installed application in the above example is launched subsequently to its installation, there may be other methods of launching applications. One example method is to change the status indication in the version list box 810 from “Available” to “Ready” when the application is installed and then to prompt the user to click this “Ready” application before initiating a launching process.

As can be seen from comparison between FIG. 15 and FIG. 16, the sequence of FIG. 15 omits steps ST122, ST123, and ST124 in FIG. 16. That is, the application management server 100 is allowed to skip those installation steps and directly proceed to the launching step when the requested application is previously installed on execution servers 200, 300, and 400. Accordingly, the application is launched more quickly than in the case of launching a non-installed application.

The following section will discuss another way of installing applications, as well as a method of uninstalling applications.

Applications may be installed on the basis of loading condition of each execution server 300 and 400, as well as of each virtual machine on the execution server 200. The term “machines” will be used below to refer to those execution servers 300 and 400 and virtual machines on the execution server 200.

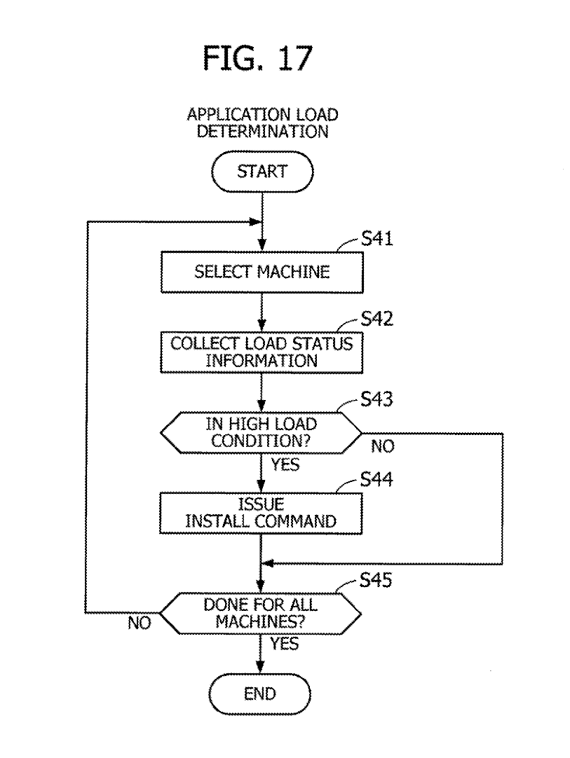

FIG. 17 is a flowchart of a process of application workload determination. Each step of FIG. 17 will be described below in the order of step numbers.

(S41) The request prediction unit 142 selects one of the machines on the execution server 200.

(S42) The request prediction unit 142 collects load status information of the selected machine. More specifically, the request prediction unit 142 consults the usage record management table 121 stored in the management data storage unit 110 to obtain the execution count and execution time of applications as the machine's load status information.

(S43) Based on the collected load status information, the request prediction unit 142 determines whether the selected machine is in a high load condition. If the selected machine is found to be in a high load condition, the process advances to step S44. If not, then the process skips to step S45. Specifically, the request prediction unit 142 determines whether the execution count and execution time indicated in the collected load status information are greater than predetermined thresholds. For example, the request prediction unit 142 finds the selected machine as being in a high load condition when the execution count exceeds 20 and when the execution time exceeds 100 hours. Otherwise, the selected machine is determined to be not in a high load condition. The thresholds may be varied depending on the performance and operational condition of execution servers.

(S44) The request prediction unit 142 identifies the operating system, applications, and their versions on the machine selected at step S41. For example, in the case where a virtual machine on the execution server 200 is selected, the request prediction unit 142 identifies the operating system, applications, and their versions on that virtual machine. For another example, in the case where the execution server 300 is selected, the request prediction unit 142 identifies the same on that physical machine. The request prediction unit 142 then issues an install command to the installation control unit 150 which includes the identified operating system, applications, and versions.

(S45) The request prediction unit 142 determines whether the above processing has been done for all machines. If it has, then the process is terminated. If there are remaining machines, the process returns to step S41 after finalizing the processing for the currently selected machine.

With the above-described processing, the request prediction unit 142 outputs an install command to the installation control unit 150 when a machine is found to be in a high load condition. This install command specifies the application installed on that machine. Based on this install command, the installation control unit 150 selects an appropriate execution server 200, 300, or 400 as the target server, and installs the specified application on the selected server in the way discussed in FIG. 12.

For example, when a virtual machine is found to be in a high load condition, another virtual machine is then built on the execution server 200, including the application running on the highly loaded virtual machine. Also, when an execution server 300 is found to be in a high load condition, the application running on the highly loaded execution server 300 is then installed on another execution server 400. Regarding the former case, the new virtual machine may be built on some other execution server (not illustrated in FIG. 2) than the execution server 200 if that alternative server supports virtual machines.

In the above-described step S44, the request prediction unit 142 identifies which operating system is running on the selected machine, and the same operating system is specified in a subsequent install command. The embodiment is, however, not limited by this specific configuration. The request prediction unit 142 may be modified to specify other operating system in the install command.

The request prediction unit 142 may also be modified to determine whether to add an application on the basis of load status information, such as CPU usage and memory consumption, of execution servers 200, 300, and 400. In this case, the request prediction unit 142 may detect a high load condition from, for example, the duration of a high CPU usage exceeding a threshold.

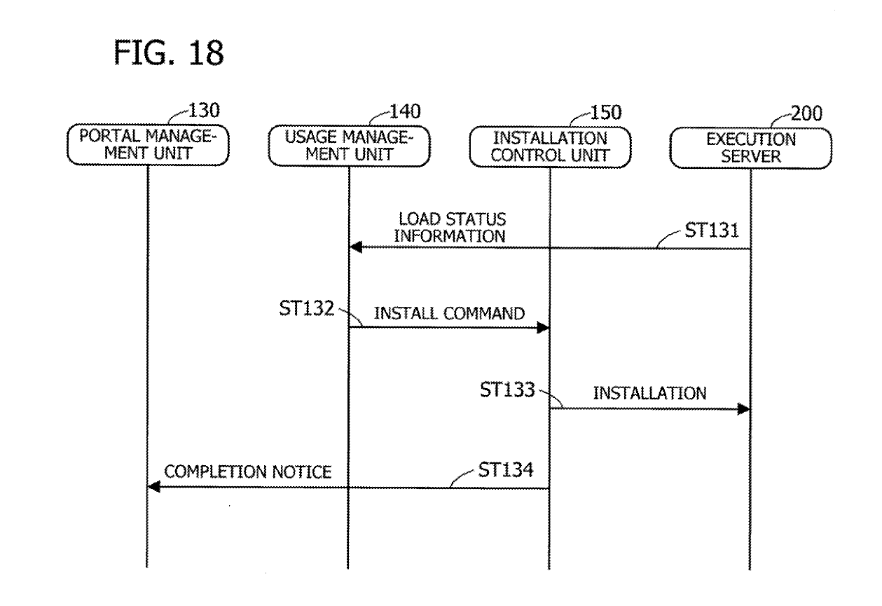

FIG. 18 is a sequence diagram illustrating how applications are added depending of the machine load. Each step of FIG. 18 will be described below in the order of step numbers. While FIG. 18 exemplifies interaction with one execution server 200 for illustrative purposes, the sequence diagram may similarly apply to other execution servers 300 and 400.

(ST131) The usage management unit 140 collects information on the loading condition of a virtual machine running on the execution server 200. The usage management unit 140 executes such information collection at predetermined intervals and uses the collected load status information in the processing of application load determination discussed above in FIG. 17. As a result of this determination, the usage management unit 140 detects that the virtual machine is facing a high load condition. It is assumed here that the virtual machine is executing application APP1 version 3.0.

(ST132) The usage management unit 140 issues an install command to the installation control unit 150 to install application APP1 version 3.0 on OS-A. The installation control unit 150 accepts this install command.

(ST133) Based on the received install command, the installation control unit 150 installs application APP1 version 3.0 on the execution server 200 in the way discussed in FIG. 12. Upon completion of this installation, the installation control unit 150 updates the application management table 111 in the management data storage unit 110 to register information on the installed application APP1.

(ST134) The installation control unit 150 outputs a completion notice to inform the portal management unit 130 of completion of the installation. This completion notice includes an execution command for launching the application on the newly added virtual machine. Upon receipt of the completion notice, the portal management unit 130 consults the application management table 111 to include its updated content in a version selection screen 800 when it is subsequently produced. For example, the version selection screen 800 may include a version list box 810 in which the application APP1 version 3.0 is marked “Ready,” so that the application will readily be launched on the newly installed virtual machine upon selection of that version by the user. For another example, the version selection screen 800 for an application may be configured to indicate the number of available machines and a listing of available machines. The portal management unit 130 may update such indications according to new content of the application management table 111.

With the above-described processing, the application management server 100 installs an application on other machine when virtual machines on the execution server 200, as well as the execution servers 300 and 400, are heavily loaded. When the user selects that application for launching, the request is directed to the machine on which the application has just been installed. It is therefore possible to prevent the load from excessively concentrating into a single machine. It is also possible to reduce the time for responding to requests from terminal devices 21, 22, and 23.

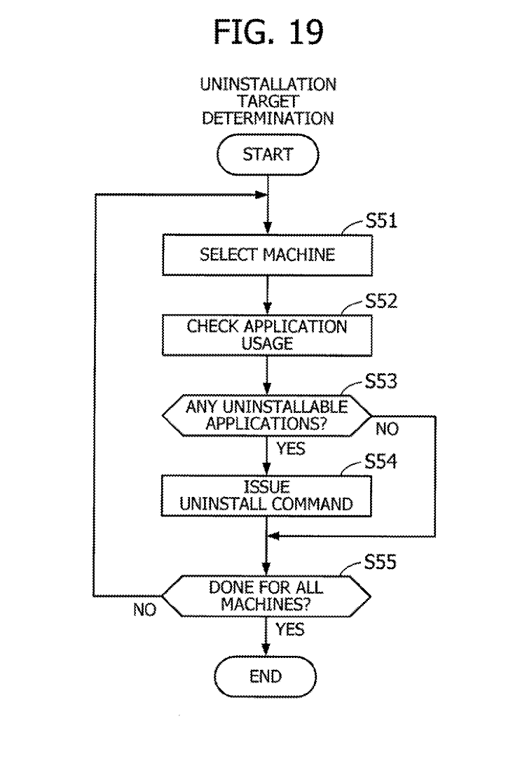

A process of uninstalling applications from execution servers 200, 300, and 400 will now be described below. FIG. 19 is a flowchart of a process of determining which applications to uninstall. Each step of FIG. 19 will be described below in the order of step numbers.

(S51) With reference to the usage record management table 121 stored in the log data storage unit 120, the request prediction unit 142 selects one of the machines registered therein.

(S52) With reference to the usage record management table 121 stored in the log data storage unit 120, the request prediction unit 142 checks the usage of applications in the selected machine.

(S53) Based on the usage of applications, the request prediction unit 142 determines whether there are any applications that may be uninstalled from the selected machine. If uninstallable applications are found, the process advances to step S54. If there are no uninstallable applications, the process skips to step S55. For example, some application may have a value of zero in either or both of the execution count and execution time fields of the usage record management table 121. Those applications are considered not to have been used during a specific period (e.g., recent one week). The request prediction unit 142 thus finds those applications to be uninstallable.

(S54) The request prediction unit 142 issues an uninstall command to the installation control unit 150 to uninstall the applications determined to be uninstallable at step S53. This uninstall command contains information about the operating system, applications to be uninstalled, their versions, and target machines.

(S55) The request prediction unit 142 determines whether the above processing has been done for all machines. If it has, then the process is terminated. If there are remaining machines, the process returns to step S51 after finalizing the processing for the currently selected machine.

With the above-described processing, the request prediction unit 142 identifies uninstallable applications on each machine and outputs an uninstall command to the installation control unit 150. At the foregoing step S54, the request prediction unit 142 may output an uninstall command for all uninstallable applications. As an alternative, the request prediction unit 142 may output an uninstall command selectively for a part of uninstallable applications depending on the load condition, preferably those that are unlikely to be used for the foreseeable future. For example, the request prediction unit 142 may check the last used date of each uninstallable application and initiate uninstallation of those with older dates in preference to those with newer dates.

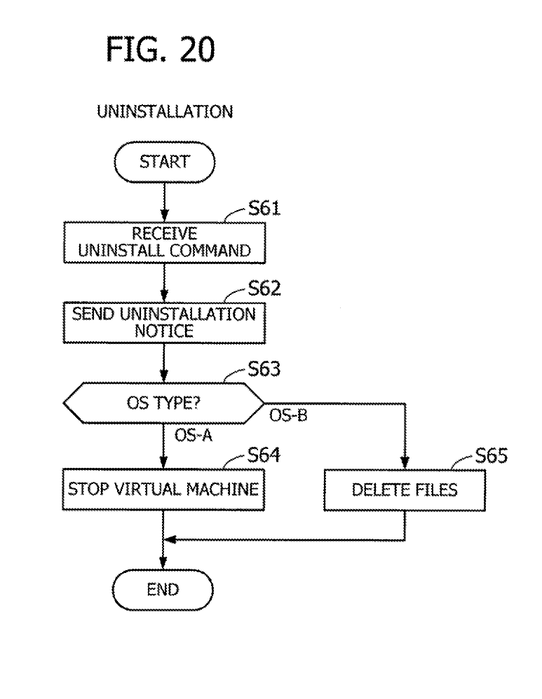

FIG. 20 is a flowchart of an uninstallation process. Each step of FIG. 20 will be described below in the order of step numbers.

(S61) The request reception unit 151 receives an uninstall command from the request prediction unit 142.

(S62) The request reception unit 151 sends an uninstallation notice to notify the portal management unit 130 of uninstallation of applications specified by the uninstall command. Upon receipt of this uninstallation notice, the portal management unit 130 modifies the application management server 100 not to allow the user to select those applications. The request reception unit 151 forwards the uninstall command to the execution environment deletion unit 153.

(S63) The execution environment deletion unit 153 determines which operating system the uninstall command specifies. If it is OS-A, the process advances to step S64. If it is OS-B, the process advances to step S65.

(S64) The execution environment deletion unit 153 commands the execution server 200 to stop the virtual machine specified by the uninstall command. In response, the execution server 200 stops the specified virtual machine and deletes its relevant virtual machine image file.

(S65) The execution environment deletion unit 153 deletes application files specified by the uninstall command, from the execution servers 300 and 400.

With the above-described processing, the execution environment deletion unit 153 uninstalls applications from each relevant machine according to an uninstall command from the request prediction unit 142.

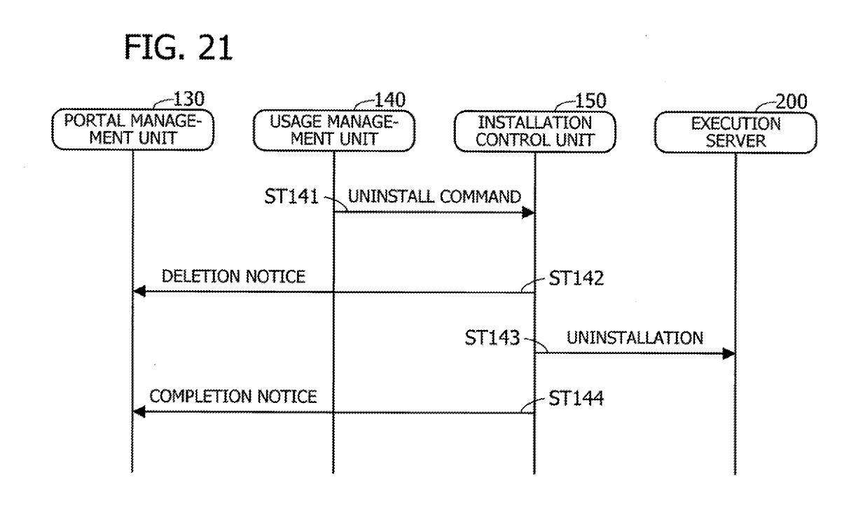

FIG. 21 is a sequence diagram illustrating how an uninstallation process is executed. Each step of FIG. 21 will be described below in the order of step numbers. While only one execution server 200 is involved in the illustrated flow, the same flow may similarly apply to other execution servers 300 and 400.

(ST141) At predetermined intervals, the usage management unit 140 determines which applications to uninstall in the way described in FIG. 19. During this course, the usage management unit 140 finds, for example, that application APP1 version 3.0 on virtual machine VM2 is not used. The usage management unit 140 then issues an uninstall command for this application to the installation control unit 150. The installation control unit 150 receives this uninstall command.

(ST142) The installation control unit 150 sends a deletion notice to the portal management unit 130 to inform that application APP1 version 3.0 on virtual machine VM2 is to be uninstalled. The portal management unit 130 receives this deletion notice. The portal management unit 130 modifies the version selection screen 800 not to allow the user to select the application to be uninstalled.

(ST143) Based on the received uninstall command, the installation control unit 150 sends a stop command of virtual machine VM2 to the execution server 200. In response to this stop command, the installation control unit 150 performs an uninstallation process in the way described in FIG. 20. The installation control unit 150 causes the execution server 200 to stop virtual machine VM2 and delete its relevant virtual machine image file.

(ST144) The installation control unit 150 outputs a completion notice to inform the portal management unit 130 of completion of the uninstallation. Upon receipt of this completion notice, the portal management unit 130 consults the application management table 111 to include its updated content in a version selection screen 800 when it is subsequently produced. More specifically, the menu generation unit 131 will change the indication for the newly installed application APP1 version 3.0, from “Ready” to “Available” in the version list box 810. It is noted, however, that the indication in the version list box 810 stays unchanged in the case where there are other machines accommodating the same application, so that the user is allowed to select the “Ready” version.

With the above-described processing, the application management server 100 seeks applications that may be safely uninstalled and executes uninstallation of such applications. This feature prevents execution servers 200, 300, and 400 from keeping obsolete applications installed.

The application management server 100 also reconfigures the version selection screen 800 before beginning uninstallation, so as not to allow the user to select the applications that will be uninstalled. This feature prevents the machines accommodating those applications from receiving a launch command for them.

Uninstallation of superfluous applications enables other applications to receive an allocation of released resources. This feature makes it possible to install more applications on execution servers 200, 300, and 400 when they are expected to be used, thus eliminating or reducing the launching time of applications.

The above-described uninstallation process deletes relevant virtual machine image files and application files. Alternatively, those files may be saved on the execution servers or application management server 100 in compressed form or uncompressed form. With this control applied, the application management server 100 does not have to interact with the storage server 500 when reinstalling applications. Saving applications locally in the execution servers may be particularly beneficial in terms of the time required for making those applications usable, because the execution server has only to expand relevant files.

### (c) Third Embodiment

A third embodiment will be described in detail below with reference to the accompanying drawings. As the third embodiment shares several elements with the foregoing second embodiment, the following description will mainly be directed to their differences, while not repeating description for similar things.

The foregoing second embodiment is designed to predict which application will be used subsequently to the current application and previously install the predicted application on the basis of design step definition tables 112, 112a, 112b, . . . stored in the management data storage unit 110. For efficient use of resources, it is preferable in this case that the installation of an application is performed not too long before the application starts to be used. This is because the resources such as CPU, memory, and HDD would otherwise be allocated too much to the waiting applications. The second embodiment is therefore designed to control when to install applications according to their specific use start dates.

To further reduce the time from installation of an application to its use, the third embodiment determines the timing of installation in a more precise way by taking into consideration a use plan of applications which has been received from users. The following section will describe in detail an application management server designed to provide those features.

The third embodiment assumes the structure of an information processing system similar to that of the second embodiment. For details of the underlying system structure, see FIG. 2 discussed in the second embodiment. The exception is that the system employs an application management server 100a according to the third embodiment in place of the application management server 100 discussed in FIG. 2. The application management server 100a may have a hardware configuration similar to that of the application management server 100 discussed in FIG. 4, for which the explanation is not repeated here.

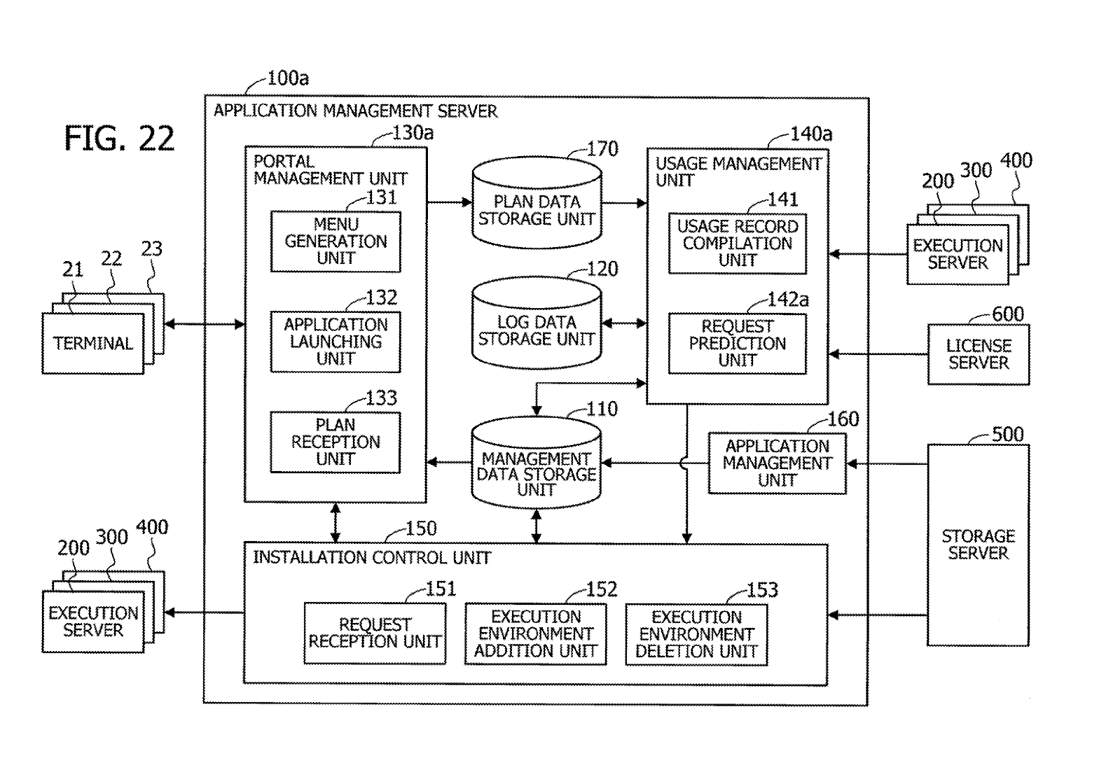

FIG. 22 is a functional block diagram of the application management server 100a according to the third embodiment. The illustrated application management server 100a includes a management data storage unit 110, a log data storage unit 120, a portal management unit 130a, a usage management unit 140a, an installation control unit 150, an application management unit 160, and a plan data storage unit 170. These functional units are implemented as software on the application management server 100a. That is, the CPU 101 executes an application management program to provide their functions. All or part of those functions may, however, be implemented as dedicated hardware components. The management data storage unit 110, log data storage unit 120, installation control unit 150, and application management unit 160 in FIG. 22 provide the same functions as those that are designated by the same reference numerals in the foregoing application management server 100 of FIG. 5. The explanation for these units are therefore omitted.

The portal management unit 130 provides terminal devices 21, 22, and 23 with a portal screen to receive a selection of applications. When starting to provide a portal screen for a specific user, the portal management unit 130 performs user authentication by prompting the user to enter his or her own user ID and password. This user authentication process may be performed on a person-to-person basis or on a project-to-project basis. The portal management unit 130 includes a plan reception unit 133 in addition to a menu generation unit 131 and an application launching unit 132. The menu generation unit 131 and application launching unit 132 are identical to their counterparts with the same reference numerals in FIG. 5.

The plan reception unit 133 receives a use plan of applications from terminal devices 21, 22, and 23. The plan reception unit 133 registers the received use plan in the form of a use plan table in the plan data storage unit 170. For example, use plans of applications may include information about what applications the user is going to use, their versions, operating system, scheduled period of use, quantity, and the like.

The usage management unit 140a manages usage of applications installed on the execution servers 200, 300, and 400. To this end, the usage management unit 140a includes a usage record compilation unit 141 and a request prediction unit 142a. The usage record compilation unit 141 is identical to its counterpart with the same reference numeral in FIG. 5.

The request prediction unit 142a predicts which application will subsequently be requested by the terminal devices 21, 22, and 23, with reference to design step definition tables 112, 112a, 112b, stored in the management data storage unit 110. The request prediction unit 142a also determines when to install the predicted application, with reference to the usage record management table 121 stored in the log data storage unit 120, as well as to the use plan tables stored in the plan data storage unit 170. The request prediction unit 142a issues an install command for the application to the installation control unit 150 at an appropriate time.

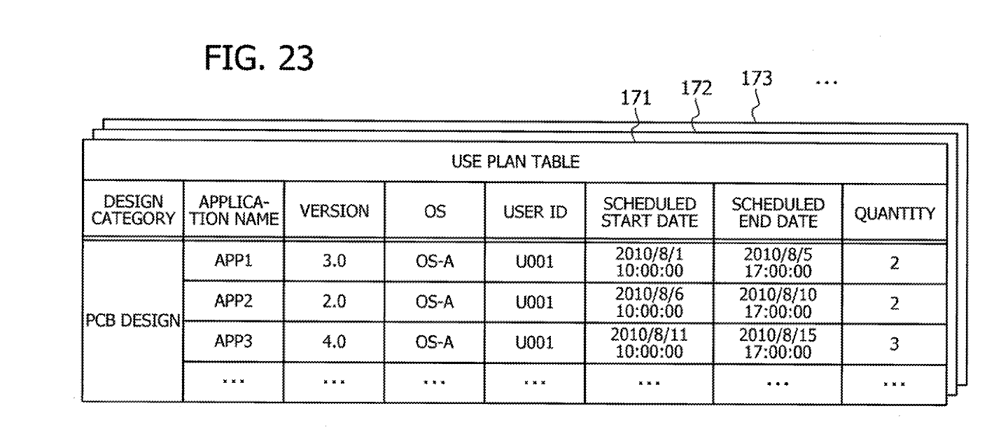

The plan data storage unit 170 stores use plan tables. FIG. 23 illustrates an example data structure of use plan tables. The illustrated use plan tables 171, 172, 173, . . . are updated by the plan reception unit 133 and stored in the plan data storage unit 170. The use plan tables 171, 172, 173, . . . have been produced for individual users. For example, the use plan table 171 represents a use plan of user U001. While the following description focuses on this use plan table 171, the same table structure may similarly apply to other use plan tables 172, 173, . . . as well.

The use plan table 171 is formed form the following data fields: “Design Category,” “Application Name,” “Version,” “OS,” “User ID,” “Scheduled Start Date,” “Scheduled End Date,” and “Quantity.” The data values horizontally arranged in this table are associated with each other to constitute a single use plan record.

The design category field indicates a specific category of circuit design projects. The application name field contains the name of each application, and the version field indicates the version of that each application. The OS field contains the name of an operating system. The user ID field contains an identifier identifying a specific user. The scheduled start date field indicates the date and time when the user is expected to start to use the application. The scheduled end date field indicates the date and time when the user is expected to end the use of the application. The quantity field indicates the quantity of applications to be used.

For example, the illustrated use plan table 171 contains a record with a design category of “PCB Design,” application name of “APP1,” version of “3.0,” OS of “OS-A,” user ID of “U001,” use start date of “2010/8/1 10:00:00,” use end date of “2010/8/5 17:00:00,” and quantity of “2.” This record means that the user identified as “U001” has a plan to use application APP1 version 3.0 on operating system OS-A for the purpose of PCB design. The record also indicates that the use of the application is scheduled to start at 10:00:00 AM on Aug. 1, 2010 and end at 5:00:00 PM on Aug. 5, 2010. Further the record indicates that the user is going to use two instances of the noted application.

The next section will describe how the above application management server 100a performs application prediction. The application management server 100a performs other processing operations similarly to the application management server 100 of the second embodiment. Description will not be repeated for those similar processing operations.

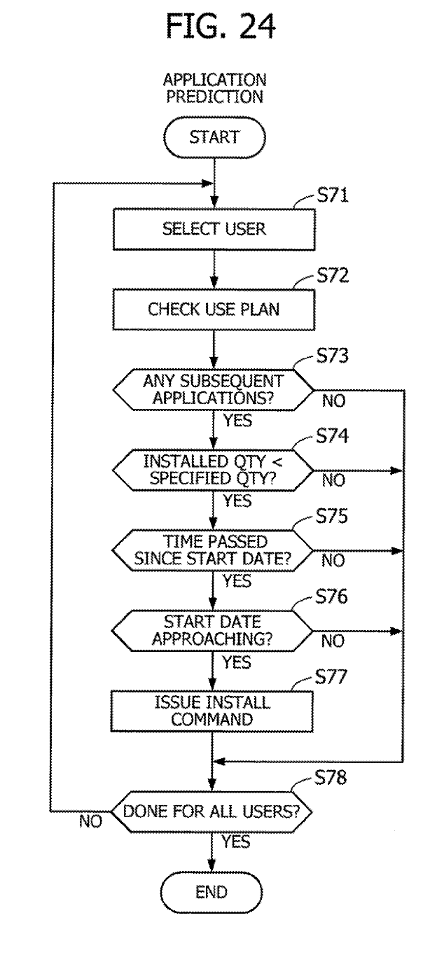

FIG. 24 is a flowchart of an application prediction process according to the third embodiment. Each step of FIG. 24 will be described below in the order of step numbers.

(S71) The request prediction unit 142a selects a user who is using an application, by consulting the usage record management table 121 stored in the log data storage unit 120. For example, the execution count field of this usage record management table 121 indicates whether each particular user is using an application. More specifically, if a certain record contains a value greater than zero in its execution count field, it means that the corresponding user is using an application during a predetermined length (e.g., one week) of period including the present. If the execution count field indicates zero in a certain record, it means that the corresponding application is not being used.

(S72) With reference to the plan data storage unit 170, the request prediction unit 142a determines with which use plan table is associated with the selected user. For example, the request prediction unit 142a selects a use plan table 171 as being associated with the user U001.

(S73) The request prediction unit 142a identifies the design category indicated in the selected use plan table. The management data storage unit 110 stores a plurality of design step definition tables 112, 112a, 112b, . . . corresponding to different design categories. The request prediction unit 142a then determines whether there is an application that follows the current application, by consulting one of those design step definition tables that matches with the identified design category. If there is an application for the subsequent step, the process advances to step S74. If there are no subsequent applications, the process skips to step S78. For example, the use plan table 171 indicates that the user U001 is using application APP1 that falls under the design category of “PCB Design.” Accordingly the request prediction unit 142a identifies a design step definition table 112 corresponding to the design category “PCB Design.” This design step definition table 112 indicates that application APP2 comes next to application APP1. The request prediction unit 142a thus concludes that there is a subsequent-step application.

(S74) With reference to the application management table 111 stored in the management data storage unit 110, the request prediction unit 142a determines whether the number of installed instances of the application is smaller than the specified quantity. If so, the process advances to step S75. If there are more instances than the specified quantity, the process skips to step S78. For example, the next record in the use plan table 171 specifies a quantity of two for the subsequent-step application APP2 version 2.0. In this case, the request prediction unit 142a determines whether there are two installed instances of application APP2 version 2.0.

(S75) With reference to the usage record management table 121 stored in the log data storage unit 120, the request prediction unit 142a determines whether a predetermined time T has passed since the use start date when the currently selected user started the current-step application. If it is found that the predetermined time T has passed, the process advances to step S76. If not, the process skips to step S78.

(S76) The request prediction unit 142a determines whether the start of the next scheduled application is approaching. If it is, the process advances to step S77. If not, the process skips to step S78. For example, the determination of whether the start is approaching may be performed as follows: (1) The request prediction unit 142a obtains the scheduled start date of the subsequent-step application from a relevant use plan table. (2) The request prediction unit 142a consults the usage record management table 121 to determine whether the current step is ahead the schedule or behind the schedule. This determination may be done by, for example, comparing the track record of use start date of the current application with its corresponding scheduled start date in the use plan table. (3) Depending on whether the current step is ahead or behind the schedule, the request prediction unit 142a corrects the scheduled start date of the subsequent-step application and then determines whether the corrected scheduled start date is approaching. Here the term “approaching” may denote, for example, that the corrected scheduled start date is within one day from the present date.

(S77) The request prediction unit 142a issues an install command for the subsequent-step application to the installation control unit 150. This install command specifies a specific operating system, application, version, and additional application quantity. The quantity indicates the difference between the number of instances installed at present and the quantity specified in the use plan table 171.

(S78) The request prediction unit 142a determines whether the above processing has been done for all users. If it has, then the process is terminated. If there are remaining users, the process returns to step S71 after finalizing the processing for the currently selected user.

With the processing described above, the request prediction unit 142a determines which application will be used next to the current one, by consulting each use plan table 171, 172, 173, . . . , and issues an install command for the determined application. The installation control unit 150 executes this installation command in the way discussed previously in FIG. 12.

According to the third embodiment, the request prediction unit 142a determines when to install applications, with further reference to a use plan entered by the user. Since installed applications may not necessarily be used right after their installation, the noted feature of the request prediction unit 142a reduces the time from installation to start of use, relative to the foregoing method of the second embodiment. The resulting free resources may then be allocated to other applications. That is, the third embodiment enables more efficient use of resources than the method proposed in the second embodiment.

What the user enters as a use plan is only a projected schedule, and the design steps do not always proceed as scheduled. That is, the scheduled start date and scheduled completion date stated in the use plan tables 171, 172, 173, . . . may not coincide with the actual progress of the steps. The request prediction unit 142a is thus designed to adjust the timing of installation on the basis of actual usage of applications, taking into consideration the possibility of advancement or delay of the steps. This feature contributes to further reduction of the time from installation to start of use, as well as to more efficient use of resources.

While the above description of the third embodiment has assumed that the request prediction unit 142a uses design step definition tables 112, 112a, 112b, . . . to predict a next application, the embodiment may be modified to rely only on the use plan tables 171, 172, 173, . . . to do the same. When this is the case, the sequence of applications in the use plan tables 171, 172, 173, . . . may be defined by user inputs.

### (d) Fourth Embodiment

A fourth embodiment will be described in detail below with reference to the accompanying drawings. As the fourth embodiment shares several elements with the foregoing second and third embodiments, the following description will mainly be directed to the differences from the preceding embodiments, without repeating explanations for similar things.

The foregoing third embodiment is designed to determine when to install predicted applications on the basis of use plan tables 171, 172, 173, . . . stored in the plan data storage unit 170. The fourth embodiment provides a method of previously determining parameters for correcting the timing of installation, taking both usage records and use plans into consideration.

The fourth embodiment assumes the structure of an information processing system similar to that of the second embodiment. For details of the underlying system structure, see FIG. 2 discussed in the second embodiment. The exception is that the system employs an application management server 100b according to the fourth embodiment in place of the application management server 100 in FIG. 2. The application management server 100b may have a hardware configuration similar to that of the application management server 100 discussed in FIG. 4, for which the explanation is not repeated here.

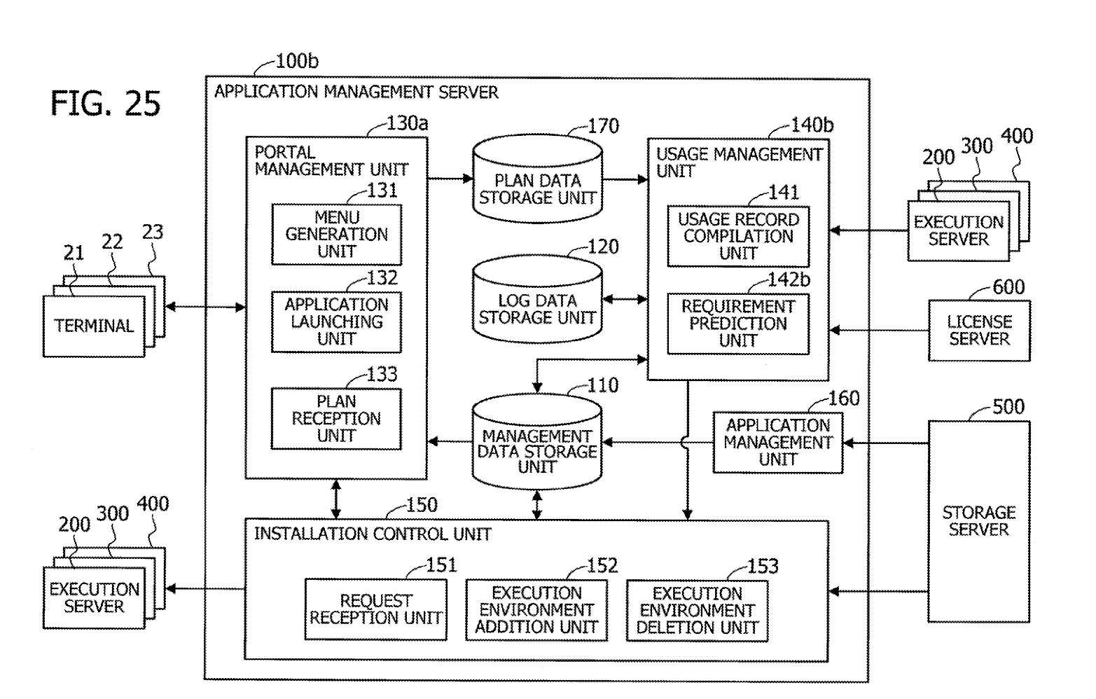

FIG. 25 is a functional block diagram of the application management server 100b according to the fourth embodiment. The illustrated application management server 100b includes a management data storage unit 110, a log data storage unit 120, a portal management unit 130a, a usage management unit 140b, an installation control unit 150, an application management unit 160, and a plan data storage unit 170. These functional units are implemented as software on the application management server 100b. That is, the CPU 101 executes an application management program to provide their functions. All or part of those functions may, however, be implemented as dedicated hardware components.

The management data storage unit 110, log data storage unit 120, installation control unit 150, and application management unit 160 in FIG. 25 provide the same functions as those that are designated by the same reference numerals in the foregoing application management server 100 of FIG. 5. The explanation for these units are therefore omitted. Also, the portal management unit 130a and plan data storage unit 170 in FIG. 25 provide the same functions as those that are designated by the same reference numerals in the foregoing application management server 100a of FIG. 22. The explanation for these units are also omitted.

The usage management unit 140b manages the actual usage of applications installed on execution servers 200, 300, and 400. The usage management unit 140b includes a usage record compilation unit 141 and a request prediction unit 142b. The usage record compilation unit 141 is identical to its counterpart with the same reference numeral in FIG. 5.

The request prediction unit 142b predicts which application will subsequently be requested by the terminal devices 21, 22, and 23, with reference to design step definition tables 112, 112a, 112b, stored in the management data storage unit 110. The request prediction unit 142b also determines, in advance, several parameters for correcting the timing of installation of each predicted application, with reference to the usage record management table 121 stored in the log data storage unit 120, as well as to use plan tables 171, 172, 173, . . . stored in the plan data storage unit 170. The request prediction unit 142b corrects the scheduled use start date in a relevant use plan table 171, 172, 173, . . . before determining when to install the predicted application. The request prediction unit 142b then issues an install command to the installation control unit 150 at an appropriate time according to the corrected use start date.

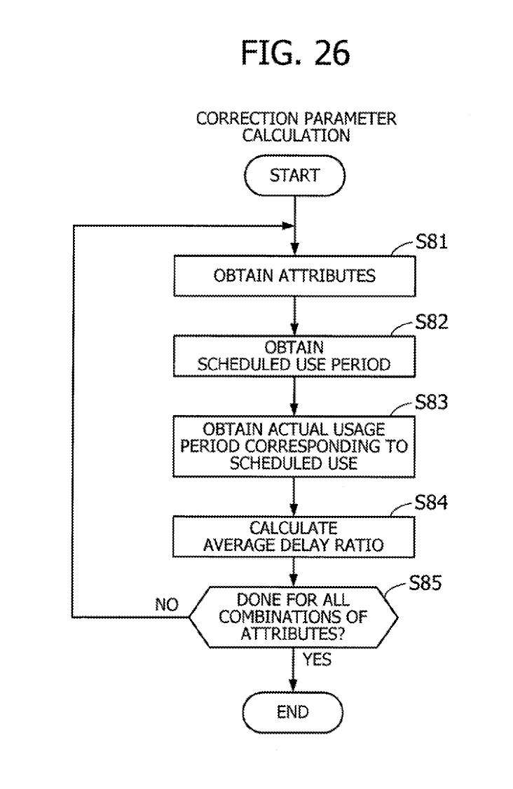

FIG. 26 is a flowchart of a process of correction parameter calculation. Each step of FIG. 26 will be described below in the order of step numbers.

(S81) The request prediction unit 142b obtains some attributes from a use plan table 171, 172, 173, . . . in the plan data storage unit 170. The term “attributes” may be, but not limited to, a specific combination of operating system, application, and version. For example, the request prediction unit 142b obtains from the use plan table 171a combination of operating system “OS-A,” application “APP1,” and version “3.0” as a set of attributes.

(S82) The request prediction unit 142b searches the relevant use plan table 171, 172, 173, . . . for use plan records that match with the obtained attributes. The request prediction unit 142b obtains a scheduled use period from each retrieved record.

(S83) With reference to the usage record management table 121 stored in the log data storage unit 120, the request prediction unit 142b obtains usage records corresponding to the use plan records obtained at step S82. For example, the usage record management table 121 may contain a usage record whose attributes match with those of a specific use plan record and whose usage period is closest to the scheduled use period of that use plan record. The request prediction unit 142b determines such usage records as corresponding to the given use plan records. The request prediction unit 142b then obtains an actual usage period from each retrieved usage record.

(S84) The request prediction unit 142b calculates an average delay ratio N (%) of the step involving the currently selected attributes by comparing the scheduled use period with its corresponding actual usage period. This average delay ratio N serves a correction parameter for the attributes. That is, the average delay ratio N corresponding to a specific set of attributes is used to correct the scheduled start date and scheduled end date of a planned step that involves those attributes.

(S85) The use plan tables 171, 172, 173, . . . may contain various combinations of attributes. The request prediction unit 142b determines whether the average delay ratios have been calculated for all those combinations of attributes. If all combinations are done, the process is terminated. If there are remaining combinations, the process returns to step S81.

With the above-described processing, the request prediction unit 142b previously calculates an average delay ratio for each set of attributes. When a specific use plan is given for installation of applications, the request prediction unit 142b corrects scheduled start date and scheduled end date in the given use plan by using the previously calculated average delay ratios. The request prediction unit 142b then determines when to install applications on the basis of the corrected schedules.

More specifically, the correction based on an average delay ratio N may be achieved by executing the following processing, instead of step S76 of FIG. 24 discussed as part of the third embodiment. That is: (1)

The request prediction unit 142b obtains scheduled start date of the subsequent-step application from a relevant use plan table. (2) The request prediction unit 142b obtains scheduled end date and attributes of the current-step application from a relevant use plan table. (3) The request prediction unit 142b corrects the scheduled use end date of the current-step application on the basis of an average delay rate corresponding to the obtained attributes. For example, when the scheduled period is ten days in length, the request prediction unit 142b corrects the scheduled use end date by shortening or lengthening the period by 10 (days)×N (%) depending on whether the current step is ahead or behind the schedule. The request prediction unit 142b also applies this correction to the scheduled start date of the subsequent-step application, shifting it backward or forward by the same amount of time. The request prediction unit 142b then determines whether the corrected scheduled start date is approaching.

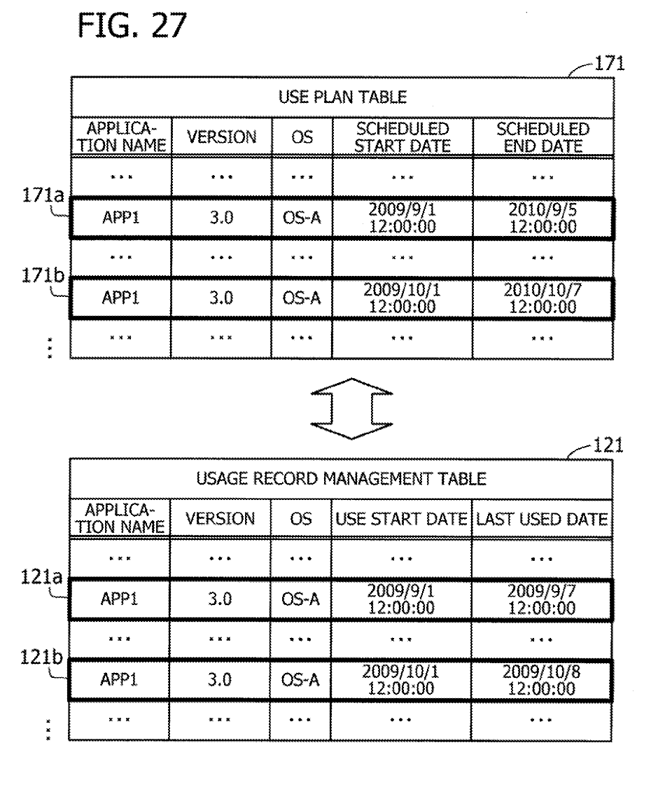

FIG. 27 illustrates a specific example of correction parameter calculation. The illustrated use plan table 171 in the plan data storage unit 170 includes use plan records 171a, 171b, . . . , which are a collection of records that share an application name of “APP1,” a version number of “3.0,” and an operating system type of “OS-A” as their attributes. On the other hand, the illustrated usage record management table 121 in the log data storage unit 120 includes usage records 121a, 121b, . . . , which are a collection of records that share an application name of “APP1,” a version number of “3.0,” and an operating system type of “OS-A” as their attributes. It is noted that FIG. 27 omits details of other records for simplicity purposes.

The request prediction unit 142b compares the use plan records 171a, 171b, . . . with their corresponding usage records 121a, 121b, . . . to calculate an average delay ratio corresponding the above attributes. For example, the illustrated usage record 121a is a track record representing how the user actually used the application scheduled in one use plan record 171a. Specifically the usage record 121a indicates that the user spent seven days, as opposed to the five-day schedule in the use plan record 171a, which amounts to a delay rate of 140% (=7/5×100. For another example, the usage record 121b is a track record corresponds to another use plan record 171b. This usage record 121b indicates that the user spent eight days, as opposed to the seven-day schedule in the use plan record 171a, which amounts to a delay rate of 114% (=8/7×100).

As can be seen from the above examples, each use plan record 171a, 171b, . . . and its corresponding and usage record 121a, 121b, . . . are subjected to the calculation of delay rates, and their mean value is stored as the average delay ratio N in, for example, the management data storage unit 110, being associated with a specific combination of attributes. By using this prepared data, the scheduled start and end dates of each planned application are corrected accurately. With the schedule period corrected in this way, the request prediction unit 142b determines when to install subsequent applications in a proper way. This feature makes it possible to further reduce the period from installation of an application to start of its use, as well as to operate the information processing system more efficiently.

While the above-described fourth embodiment uses combinations of OS, application, and version as an example of attributes, the embodiment is not limited by those specific data items. For example, the attributes may include user ID, in which case the request prediction unit 142b may be able to calculate the average delay rate, taking into consideration an individual user's tendency of track records against his or her use plans.

The fourth embodiment may further be modified to calculate other correction parameters than the average delay ratio N. For example, a dispersion of delayed dates may be calculated from usage records 121a, 121b, . . . in comparison with use plan records 171a, 171b, . . . , and based on this distribution, the request prediction unit 142b calculates N (%) at which the application is expected at a specified probability (e.g., 80%) to be finished before the user requests its execution. The request prediction unit 142b then uses this N as a correction parameter.

Various embodiments of a software management apparatus, method, and program have been described. Those proposed techniques contribute to efficient on-demand software execution in an information processing system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A software management apparatus for managing software that is executed, upon request from a first information processing apparatus, by one or more second information processing apparatuses, the software management apparatus comprising:
a storage unit which stores execution order information indicating in what order a plurality of pieces of software are used;
a prediction unit which monitors progress of first software on the second information processing apparatuses and predicts second software that is expected to be requested from the first information processing apparatus subsequently to the first software, based on the progress of the first software and the execution order information stored in the storage unit; and
an installation unit which installs the predicted second software on at least one of the second information processing apparatuses.

2. The software management apparatus according to claim 1, wherein the prediction unit controls timing of installation of the second software, based on execution start time at which the first software is executed on the second information processing apparatuses.

3. The software management apparatus according to claim 2, wherein:
the storage unit further stores plan data that indicates a scheduled use time of each piece of software; and
the prediction unit controls timing of installation of the second software, based on the scheduled use time of the second software which is indicated by the plan data stored in the storage unit, in addition to the execution start time of the first software.

4. The software management apparatus according to claim 1, further comprising a screen providing unit to send screen data to the first information processing apparatus when the second software is installed, the screen data indicating that the second software is ready to be requested by the first information processing apparatus.

5. The software management apparatus according to claim 4, wherein:
the installation unit uninstalls the first software from one or more of the second information processing apparatuses, based on the progress of the first software on the second information processing apparatuses; and
the screen providing unit sends another piece of screen data to the first information processing apparatus to indicate that the first software is not available for selection as software to be requested.

6. The software management apparatus according to claim 1, wherein the installation of the second software by the installation unit includes copying programs corresponding to the second software from a first storage device to a second storage device used by the second information processing apparatuses, or decompressing compressed programs corresponding to the second software, or both the copying and the decompressing.

7. A software management method for managing software to be executed, upon request from a first information processing apparatus, by one or more second information processing apparatuses, the software management method comprising:
monitoring progress of first software on the second information processing apparatuses;
predicting second software that is expected to be requested from the first information processing apparatus subsequently to the first software, based on the progress of the first software on the second information processing apparatuses, as well as on the execution order information stored in a storage device; and
installing the predicted second software on at least one of the second information processing apparatuses.

8. A non-transitory computer-readable medium storing a program for managing software to be executed, upon request from a first information processing apparatus, by one or more second information processing apparatuses, the program causing a computer system to perform a procedure comprising:
monitoring progress of first software on the second information processing apparatuses;
predicting second software that is expected to be requested from the first information processing apparatus subsequently to the first software, based on the progress of the first software on the second information processing apparatuses, as well as on the execution order information stored in a storage device; and
installing the predicted second software on at least one of the second information processing apparatuses.
